(19) United States
(12) Patent Application Publication
(10) Pub. No.: US 2007/0158163 A1
(43) Pub. Date: Jul. 12, 2007

(54) Separation device for elongated parts and device for transporting said parts

(75) Inventors: Johann Kritzinger, Frankenburg (AT); Andreas Zoitl, Niederthalheim (AT)

Correspondence Address: WILLIAM COLLARD;COLLARD & ROE, P.C., 1077 NORTHERN BOULEVARD, ROSLYN, NY, 11576, US

(73) Assignee: STIWA-FERTIGUNGSTECHNIK STICHT GESELLSCHAFT M.B.H., Attnang-Puchheim (AT)

(21) Appl. No.: 10/582,744

(22) PCT Filed: Dec. 6, 2004
(86) PCT No.: PCT/AT04/00430

§ 371 Date: Jan. 3, 2007

(30) Foreign Application Priority Data
Dec. 15, 2003 (AT) A 2016/2003

(51) Int. Cl. B23Q 7/00

(52) U.S. Cl. 198/397.06; 221/174; 198/389

(57) ABSTRACT

The invention relates to a separating mechanism (12) for conveying and separating elongate parts (2) from a part quantity in a conveying direction extending transversely to their longitudinal extension, comprising a pick-up region (41) and a discharge region (51) for elongate parts (2) separated from the part quantity disposed above it, with at least one endlessly circulating, driveable conveyor element (47) extending between the pick-up region (41) and the discharge region (51), which has driver elements (46) disposed one after the other in the conveying direction (9) and extending parallel with one another transversely to the conveying direction (9). Every driver element (46) has on its external face directed towards the pick-up region (41) a recessed groove with an approximately trapezoidal cross-section extending in its longitudinal direction and open in the direction towards the pick-up region (41) for accommodating elongate parts (2) as and when necessary. A length of the recessed groove corresponds to at least twice the maximum length of the elongate part (2). The invention further relates to a system for conveying and separating elongate parts with an inlet conveyor system, a separating mechanism (12) and a discharge unit (13).

The invention relates to a separating mechanism for elongate parts, a system for conveying and separating elongate parts and a system for conveying, separating and orienting elongate parts, of the type outlined in the introductory parts of claims 1, 25 and 32.

Patent specification AT 408 730 B discloses a system for conveying and separating elongate parts from a part quantity from a conveyor mechanism extending transversely to their longitudinal extension, comprising a separating mechanism for the elongate parts disposed downstream of an inlet conveyor system in the conveying direction for a part quantity of elongate parts and a discharge system for the separated elongate parts adjoining it. The separating mechanism comprises at least two transport runs for the part quantities or individual elongate parts spaced at a distance apart from one another transversely to the conveying direction, which transport runs extend from the inlet conveyor system to the discharge conveyor system. The transport runs respectively comprise at least one driven, endlessly circulating conveyor element, in particular chain, driver elements disposed in the conveying direction in pairs at a distance one after the other in a plane extending transversely to the conveying direction, and extending in a more or less concave arrangement with respect to a horizontal conveyor plane so that each driver pair can separate the elongate parts from the part quantity.

The objective of the invention is to increase the throughput rate or discharge rate of separated and optionally correctly oriented elongate parts on a separating mechanism and propose a system for conveying, separating and optionally orienting elongate parts, as well as a separating mechanism and systems for conveying, separating and optionally orienting elongate parts which are distinctive due to their simple construction.

The objective of the invention is achieved on the basis of the features defined in the characterizing part of claim 1. The advantage of this approach is that the recessed groove of the driver elements passing alongside the randomly arranged elongate parts in the pick-up region enable the elongate parts to be removed particularly easily and carefully from the part quantity and each removed elongate part slides along guide surfaces inclined at an angle with respect to one another in the direction towards the groove base transversely to the longitudinal extension of the recessed groove until it lies with its external contour against the groove base so that the elongate part accommodated in the groove base, optionally separated, can be reliably conveyed. A particularly high throughput rate of assembly parts separated at the separating mechanism can be achieved by the invention due to the fact that the recessed groove corresponds to at least twice the maximum length of the elongate parts, which means that at least two elongate parts can be accommodated in one recessed groove one after the other in the direction of the longitudinal extension of the recessed groove.

The embodiment defined in claim 2 is also of advantage because the conveyor belt as such constitutes the driver elements, which significantly simplifies the construction of the separating mechanism as a whole.

The embodiment defined in claim 3 is also of advantage because if individual driver elements are damaged, only the individually damaged driver elements have to be replaced rather than having to change the entire conveyor element.

The embodiment defined in claim 4 is of advantage because a spacing gap between two driver elements disposed one after the other in the conveying direction remains constant both in the moving portions in which the row of driver elements disposed parallel one after the other are moved in a straight line and in the moving portions in which the driver elements disposed parallel one after the other are deflected, which reliably prevents the elongate parts from becoming stuck, especially when the driver elements move alongside the part quantity of randomly disposed elongate parts in the pick-up region. Furthermore, due to the short spacing gap, a large number of elongate parts can be conveyed even with a conveyor element of a shorter length.

The embodiment defined in claim 5 is of advantage because an elongate part is reliably prevented from becoming stuck in the spacing gap due to the uneven or waved contour of the mutually facing longitudinal edges of two successive driver elements, even if the minimum cross-sectional dimension of the elongate part is slightly smaller than the spacing gap and the conveyor element is deflected, as is the case in the pick-up region, especially in the driving portion. Accordingly, elongate parts with an extremely slim wall thickness can be separated and conveyed by the conveyor element without any difficulty.

The embodiments defined in claims 6 and 7 are also of advantage due to the fact that the strand of the conveyor element directed towards the pick-up region is divided into several portions fulfilling different functions, which enables the elongate parts to be reliably separated as they are conveyed from the pick-up region in the direction towards the discharge region. The driving portion advantageously curves in a concave arrangement where it faces the pick-up region, so that the elongate parts can be efficiently accommodated in the recessed grooves of the driver elements as they are moved past it.

As defined in claims 8 and 9, two elongate parts that are stuck to one another or have become hooked on or in one another in the area of the separation portion can be reliably separated.

As a result of the embodiments defined in claims 10 and 11, the elongate parts can firstly be automatically fed in the direction towards the driving portion solely due to the force of gravity acting on the part quantity of elongate parts in the pick-up region and, secondly, this approach makes it easier to introduce one or two elongate parts into the recessed groove of a driver element.

The embodiment defined in claim 12 is particularly well suited to elongate parts which have a tendency to become hooked with one another because the elongate parts merely slide along the inlet chute in the pick-up region, with their position essentially unchanged, in the direction towards the conveyor element but do not roll against one another.

However, the embodiment defined in claim 13 is also of advantage because the circulating motion of the conveyor element causes the elongate parts to automatically align with one another in a parallel position transversely to the conveying direction which is also suitable for onward conveyance, and the separation efficiency of the separating mechanism can be increased whilst keeping the circulation speed of the conveyor element constant.

The embodiment defined in claim 14 is of advantage because the driver elements moving alongside the part quantity of elongate parts in the region of the driving portion can be reliably supplied with elongate parts and on leaving the driving portion, elongate parts that have become hooked on one another are immediately returned from the separating region to the pick-up region.

Advantageous embodiments of the separating mechanisms are described in claims 15 and 16.

As defined in claim 17, even when the conveyor element is operating at higher circulation speeds, the drive elements connected to the conveyor element in motion are guaranteed to provide a reliable guiding action. Furthermore, even if there is a higher number of elongate parts in the pick-up region, the force of gravity acting on the conveyor element is dispersed via the drive elements to the guide tracks in the frame of the separating mechanism. As a result, any stress caused by high gravitational forces of the elongate parts will not lead to residual damage of the separating mechanism.

The embodiments defined in claims 18 to 21 are of advantage because the separated elongate parts accommodated in the recessed groove are positioned between the front and rear legs and even if separated elongate parts hooked with one another in the separating region drop down in the direction of the pick-up region, they are deflected away from the driver elements lying underneath by the deflector surface of the front leg so that elongate parts lying in position can not be carried along into the driver elements moved the underneath the separating region by the elongate parts as they drop down.

Also of advantage are the embodiments defined in claims 22 and 23, which ensure that only two separated elongate parts can ever accommodated in the recessed groove one after the other as viewed in the cross-sectional plane of the separating mechanism, but not one on top of the other. If two elongate parts are hooked on one another, they are firstly conveyed upwards from the driving portion above the recessed groove of the driver element but are automatically separated in the separating region due to the shift of the common center of gravity outside of the recessed groove in conjunction with the angled arrangement of the separating region and returned to the pick-up region.

Claim 24 describes an advantageous embodiment whereby the at least one elongate part fed to the recessed groove is centered by the guide surfaces extending at an angle towards one another.

The objective of the invention is also achieved on the basis of the features defined in the characterizing part of claim 25. The advantage of this approach is that due to the limited ratio of the number of elongate parts in the pick-up region between the first and second separating mechanism, the driver elements moving past the elongate parts piled up in the pick-up region loosen the piled-up elongate parts, thereby enabling the elongate parts to be easily removed from the pick-up region. As a result of the improved separation of the elongate parts in the driving portion already, the number of elongate parts separated in the separating region is significantly reduced, which means that a higher throughput rate of randomly fed individual elongate parts is achieved at the second separating mechanism than at the first separating mechanism. Loosening the elongate parts in the pick-up region means that the elongate parts are handled more gently as they are removed or separated from the pick-up region and conveyed along the device, even at a maximum throughput rate.

A particularly high throughput rate of assembly parts is achieved at the first separating mechanism as a result of claim 26, due to the fact that the width of the conveyor belt corresponds to at least twice the maximum length of the elongate parts.

Also of advantage is the embodiment defined in claim 27, whereby the elongate parts fed to the co-operating separating mechanism automatically slide in the direction towards the driving portion of the conveyor element due to gravitational force and the elongate parts are prevented from rolling off one another, which means that elongate parts that are particularly sensitive can be conveyed more gently.

The embodiments defined in claims 28 to 30 result in a compact mutual disposition of the first and second separating mechanism.

Also of advantage is the feature defined in claim 31, because only a part quantity of elongate parts is fed from the pick-region of the first separating mechanism to the second separating mechanism and this reduced part quantity of elongate parts in the pick-up region of the second separating mechanism can be easily separated. Accordingly, the elongate parts are already largely fed to the pick-up region of the second separating mechanism having already been separated. These pre-separated elongate parts are then able to fill a large number of recessed grooves of the driver elements moving past them, which results in an increased throughput rate.

Irrespective of the above, the objective is also achieved by the invention on the basis of the characterizing features defined in claim 32. The advantage of this approach is that the conveyor element responsible for conveying the elongate part simultaneously serves as an orienting element and the elongate part is automatically tipped about a longitudinal edge into a predefined position of readiness solely by the forward movement of the elongate part along the conveying and orienting element. This orienting mechanism is particularly suitable for elongate parts with a cross-section of an asymmetrical external contour and/or eccentric surface gravity. Accordingly, a force pulse acting transversely to the longitudinal extension of the conveyor passage transmitted by a conveyor surface portion of the conveying and driving element causes the elongate part to tip about one of its longitudinal edges. In the case of elongate parts with an eccentric center of gravity, this force pulse is applied only briefly, which means that the conveying speed of the elongate part along the orienting mechanism can be increased, which in turn has a positive knock-on effect on the throughput rate. The forward movement of the elongate part is caused exclusively by a frictional connection between it and the conveying and orienting element.

Also of advantage are the embodiments defined in claims 33 to 48. In a preferred embodiment, the conveying and orienting element is formed by driven conveying and orienting rollers or two traction means endlessly circulating in the inlet and outlet region, by means of which the elongate parts can be reliably oriented in the predefined position of readiness. A deflector element is preferably provided respectively between the individual conveying, orienting and inlet rollers, thereby preventing an elongate part from moving out of line as it is conveyed along the chute-type conveying passage or the conveying, orienting and inlet rollers. The conveying, orienting and inlet rollers are also driven synchronously and in the same direction by means of only one common drive motor.

Finally, the embodiment defined in claim 49 is of advantage, whereby an elongate part that has been incorrectly positioned or is damaged is detected by the camera system and automatically gated out. As a result, only correctly positioned and undamaged elongate parts are fed to a buffer run downstream of the second discharge unit and following it an inlet conveyor system for an assembly and/or processing unit.

The invention will be explained in more detail below with reference to examples of embodiments illustrated in the appended drawings.

Of these:

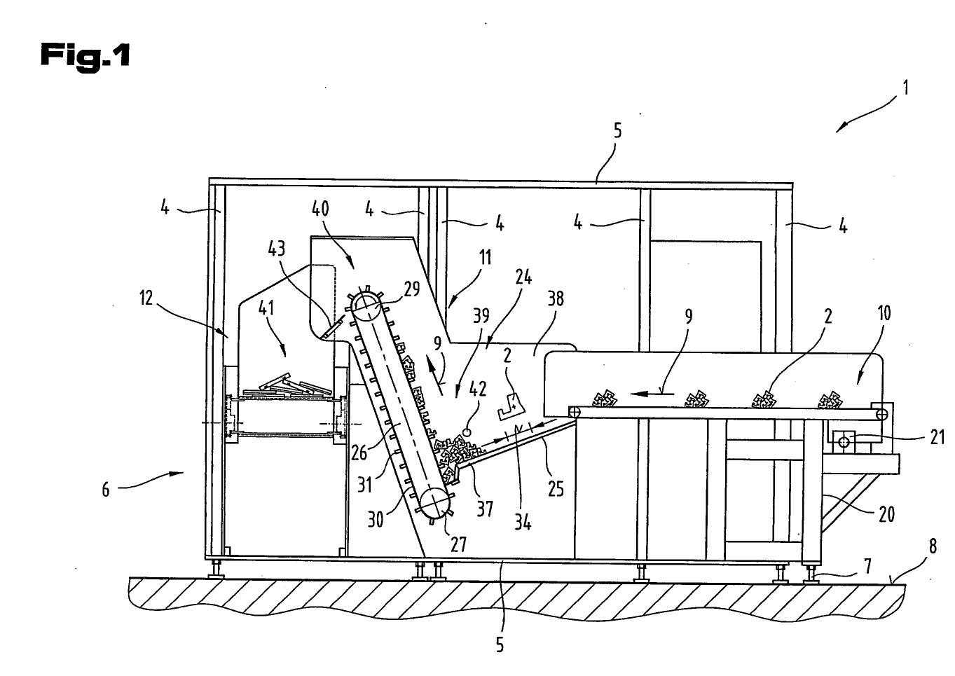

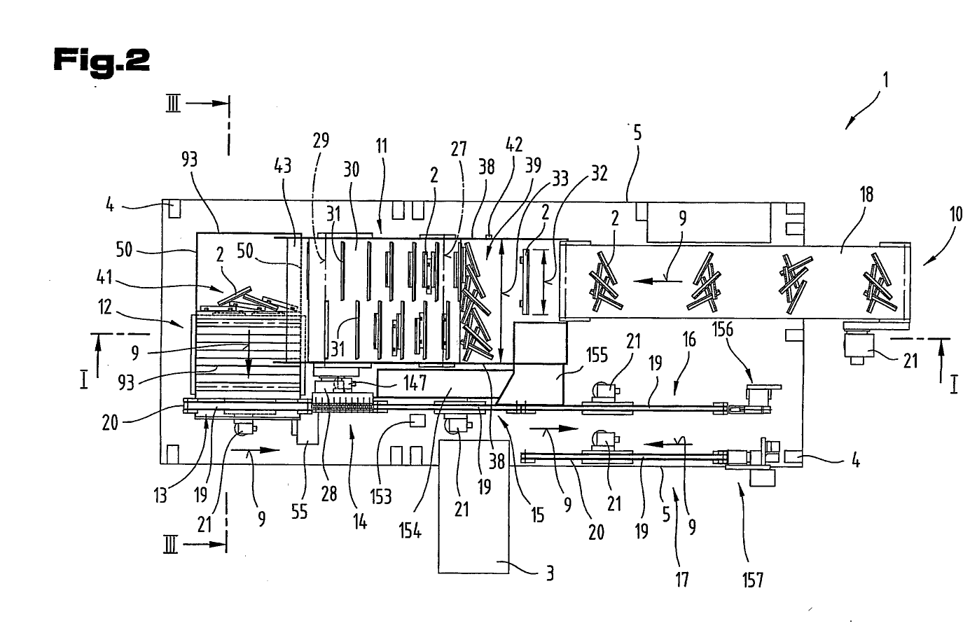

FIG. 1 is a simplified, schematic diagram showing a side view of a system proposed by the invention for conveying, separating and orienting elongate parts, seen in section along line I-I indicated in FIG. 2;

FIG. 2 is a highly simplified diagram showing a plan view of the system proposed by the invention for conveying, separating and orienting elongate parts illustrated in FIG. 1;

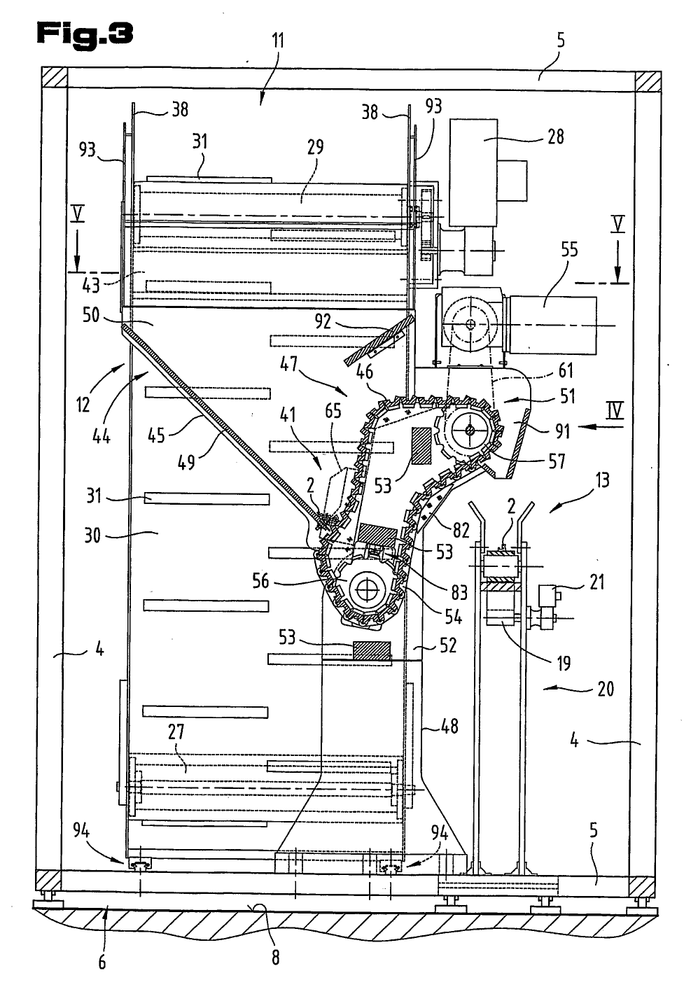

FIG. 3 is a highly simplified diagram view in section along line III-III indicated in FIG. 2 showing a view onto a first and second separating mechanism and a first discharge unit;

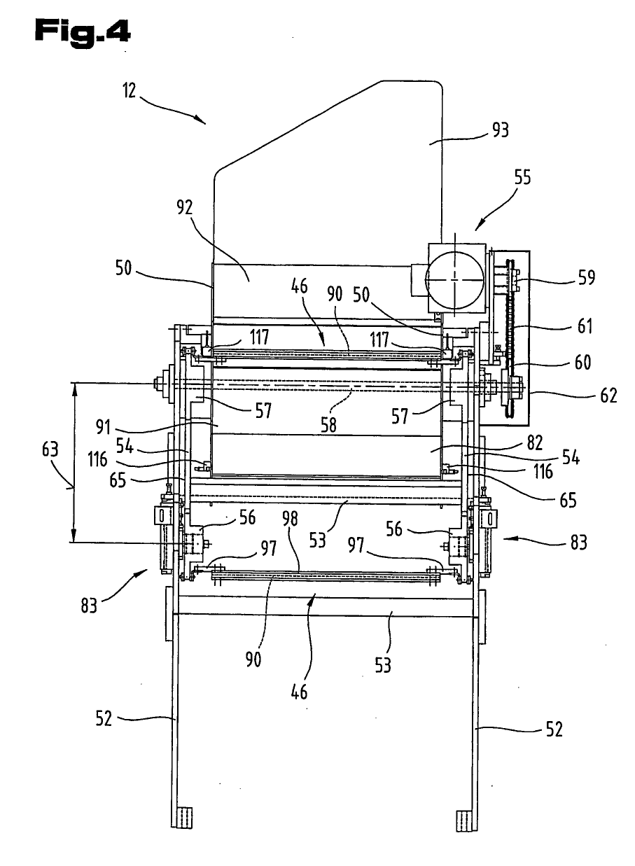

FIG. 4 is a highly simplified diagram illustrating a first embodiment of the second separating mechanism proposed by the invention viewed in the direction of arrow IV shown in FIG. 3;

FIG. 5 is a highly simplified diagram showing a plan view of a second pick-up region of an inlet chute and a part-section of the conveyor element and drive elements of the second separating mechanism, viewed along line V-V indicated in FIG. 3;

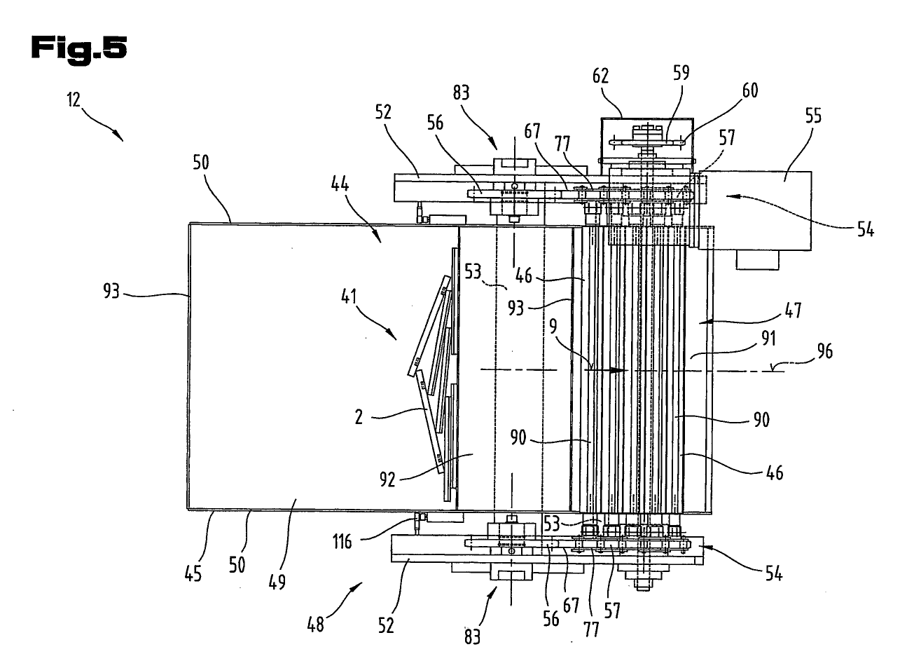

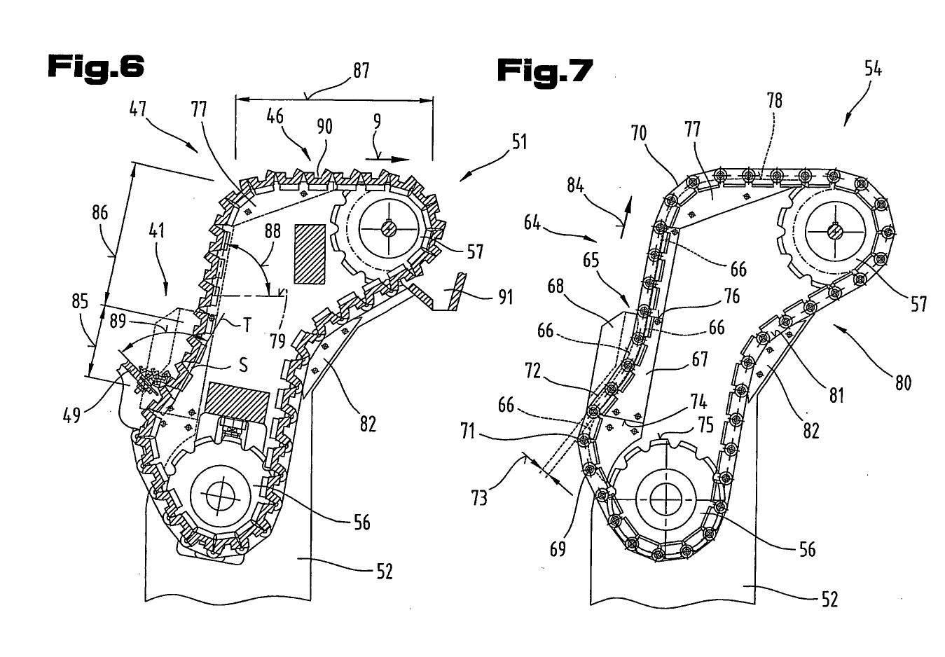

FIG. 6 shows a detail from FIG. III on an enlarged scale;

FIG. 7 is a simplified diagram showing a side view of a drive element for the conveyor element and a slide track for the drive element;

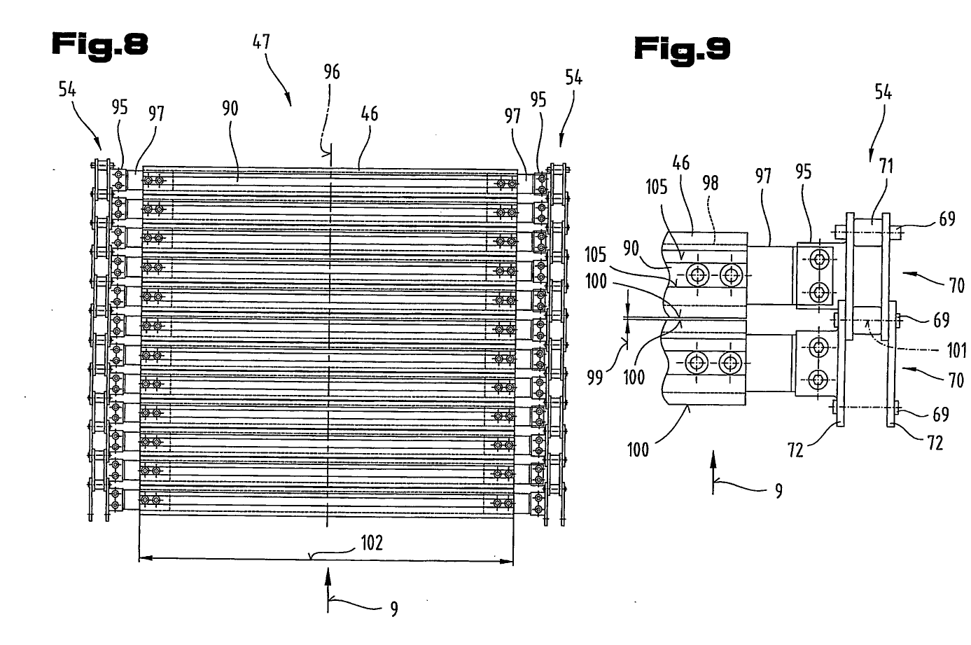

FIG. 8 is a simplified diagram showing a plan view of the conveyor element and the drive elements disposed on either side of it;

FIG. 9 shows a detail from FIG. 8 on an enlarged scale;

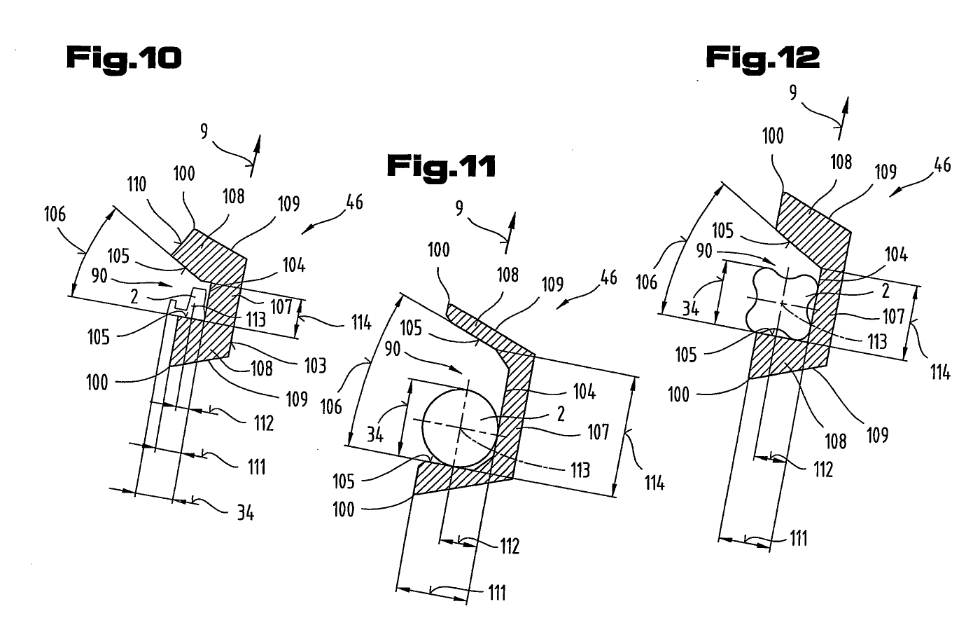

FIG. 10 shows a cross-section of a first embodiment of a driver element of the conveyor element;

FIG. 11 shows a cross-section of a second embodiment of a driver element of the conveyor element;

FIG. 12 shows a cross-section of a third embodiment of a driver element of the conveyor element;

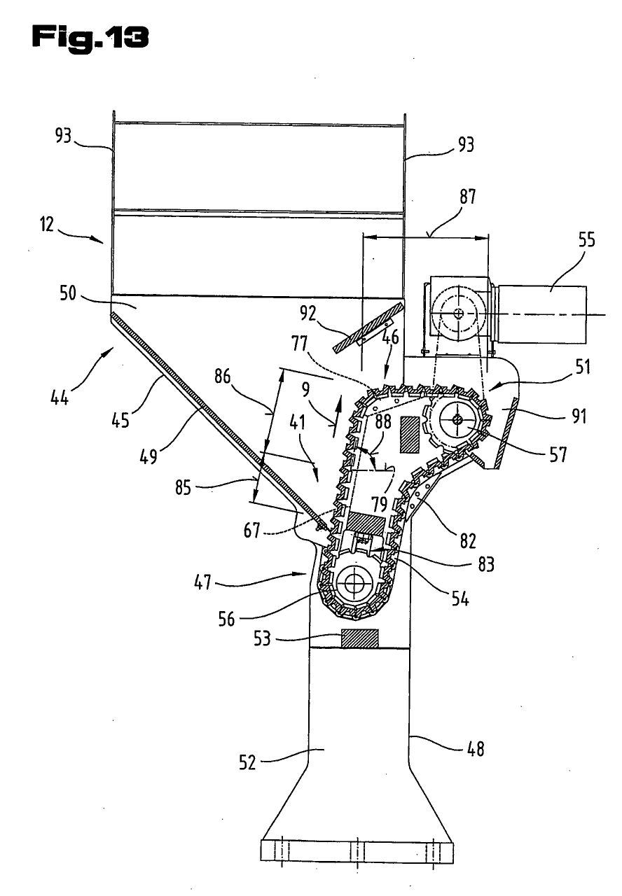

FIG. 13 is a simplified diagram illustrating a side view in partial section of another embodiment of the second separating mechanism proposed by the invention;

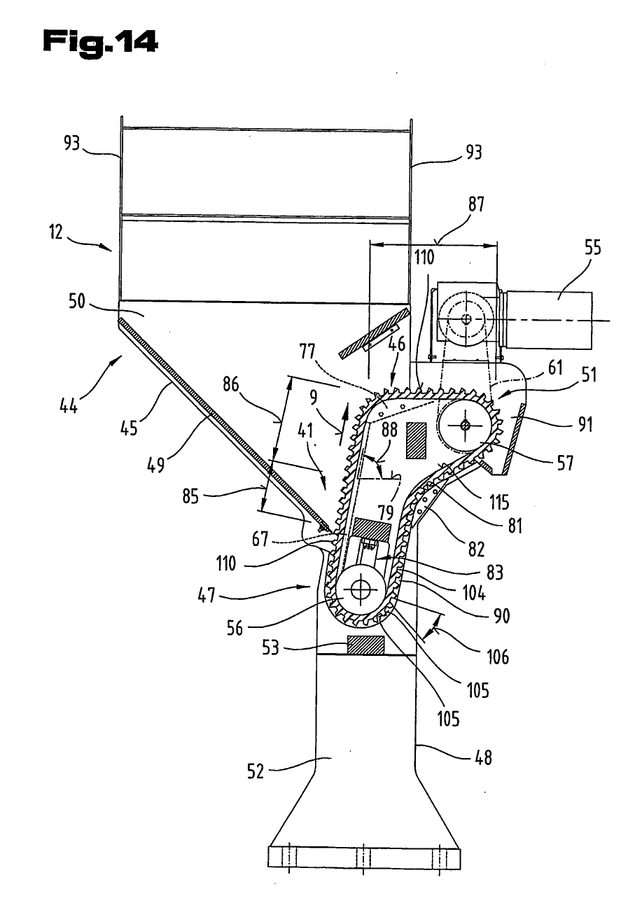

FIG. 14 is a highly simplified diagram showing a side view in partial section of another embodiment of the second separating mechanism proposed by the invention;

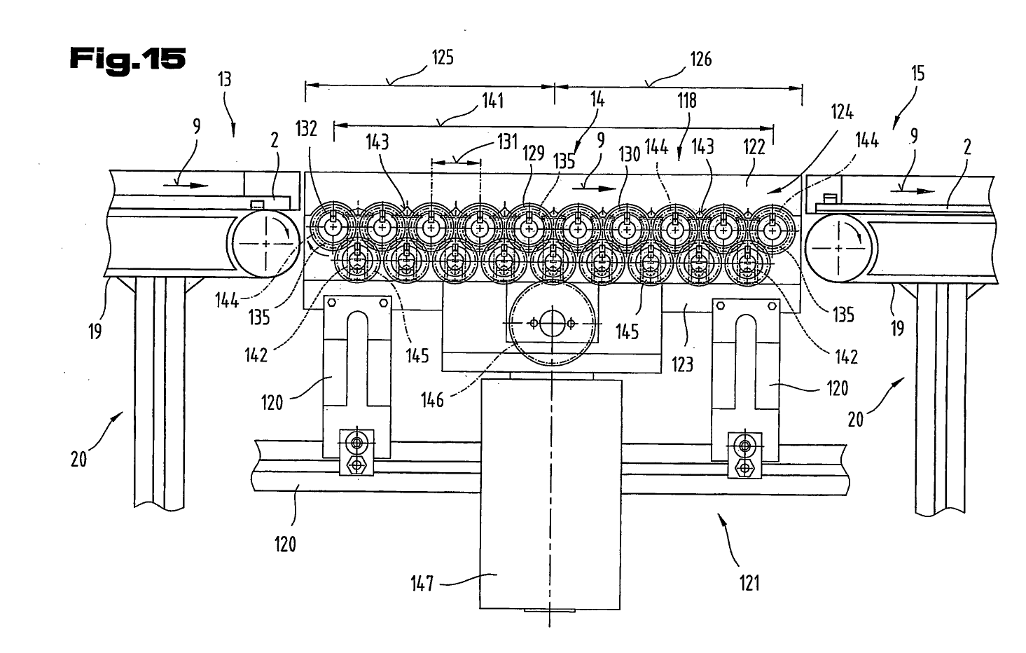

FIG. 15 is a highly simplified diagram showing a side view of an orienting mechanism proposed by the invention for elongate parts with the front side frame part removed and a first discharge unit conveying the separated elongate parts of the orienting mechanism from the second separating mechanism and a second discharge unit feeding away the elongate parts in the correct gravitational position;

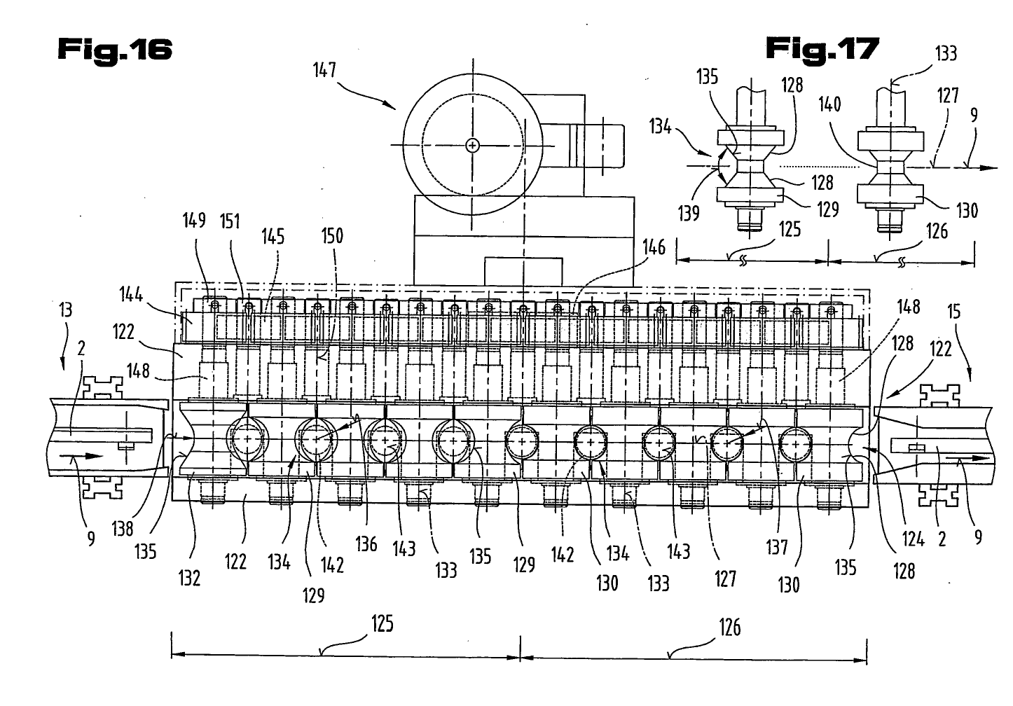

FIG. 16 is a highly simplified diagram showing a plan view of the first discharge unit, the orienting mechanism and the second discharge unit illustrated in FIG. 15;

FIG. 17 is a highly simplified diagram showing a plan view of another embodiment of conveying and orienting rollers of the orienting mechanism;

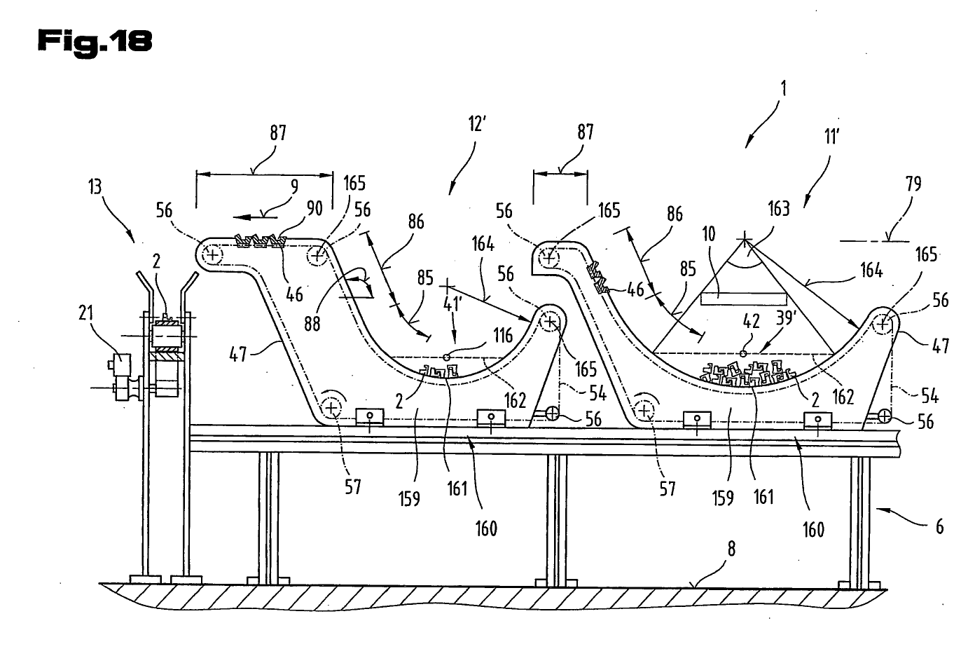

FIG. 18 is a highly simplified diagram showing a side view of a part region of the system proposed by the invention for conveying, separating and orienting elongate parts with a different embodiment of the separating mechanisms;

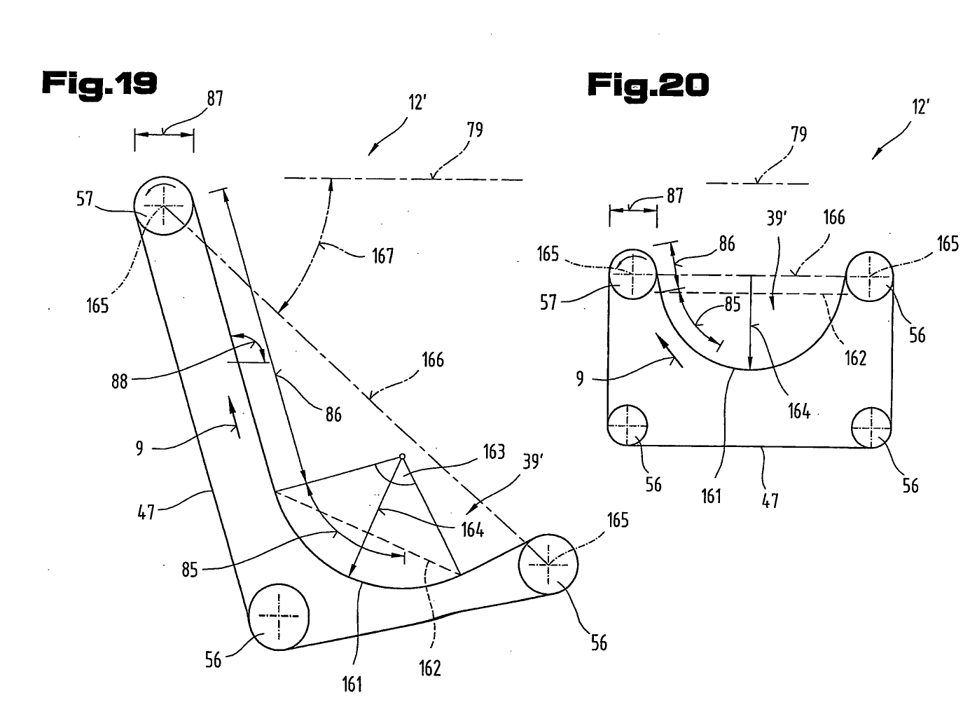

FIG. 19 is a highly simplified diagram showing a side view of a second embodiment of the separating mechanism proposed by the invention with another design for the moving track or guide system of the conveyor element;

FIG. 20 is a highly simplified diagram showing a side view of a third embodiment of the separating mechanism proposed by the invention with another design for the moving web or guide system of the conveyor element;

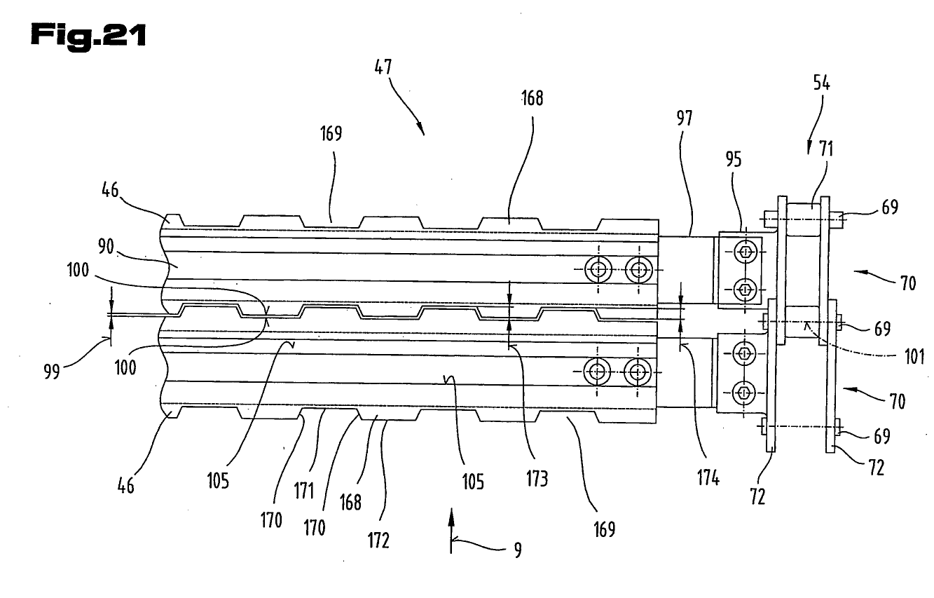

FIG. 21 is a simplified diagram showing a plan view of another embodiment of the driver elements of the conveyor element of the separating mechanism proposed by the invention.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIGS. 1 and 2 illustrate a system 1 for conveying, separating and orienting bars or strip-shaped elongate parts 2, for example from a supply container, not illustrated, to an assembly and processing unit 3 shown as a block. This system 1 has several self-supporting base frames 6 made up of several sections 4, 5 with support feet 7 which can be adjusted in height, supported on a horizontal standing surface 8, for example the floor of a factory. In the conveying direction of the elongate parts 2—indicated by arrow 9—the system 1 has, directly following one another, a first inlet conveyor system 10, a first separating mechanism 11, a second separating mechanism 12, a first discharge unit 13 for separated elongate parts 2, an orienting mechanism 14, a second discharge unit 15, a buffer run 16 and a second inlet conveyor system 17 for the assembly and processing unit 3. The separating mechanisms 11, 12 are disposed offset from one another by 90° and mounted on the base frame 6. The conveying directions—indicated by arrow 9—of the separating mechanisms 11, 12 therefore intersect at an angle of 90°.

The inlet conveyor systems 10, 17, the discharge units 13, 15 and the buffer run 16 are respectively provided in the form of a linear conveyor, in particular a belt, band or chain conveyor 18, 19. These linear conveyors each have an endlessly circulating traction means such as a belt, band or chain, and a support frame 20. The traction means is guided around at least one rotatably mounted drive element and deflector element on the support frame 20. The drive element is coupled with a drive 21, for example an electric motor. The respective drive 21 is secured on the support frame 20.

In the embodiment illustrated, the first separating mechanism 11 disposed downstream of the first inlet conveyor system 10 in the conveying direction—indicated by arrow 9- and upstream of the second separating mechanism 12 in the conveying direction—indicated by arrow 9—is provided in the form of an elevator conveyor and has a supply container 24 with a first inlet chute 25 and a belt conveyor with a frame 26. The belt conveyor projects into the supply container 24 or inlet chute 25 incorporating it by its bottom end and comprises at least one roller-type pulley block 27 and an endlessly circulating conveyor belt 30 or conveyor element coupled with a drive 28 and guided by a roller-type drive roller. On a width face directed towards the inlet chute 25, this conveyor belt 30 is provided with driver elements 31 extending in a conveying direction—indicated by arrow 9—running transversely to the longitudinal extension of the elongate parts 2 and disposed adjacent to and offset from one another in two rows in the conveying direction—indicated by arrow 9. The driver elements 31 lying respectively one after the other in a row in the conveying direction—indicated by arrow 9—are spaced at a distance apart from one another, dimensioned so that approximately one to five elongate parts 2 can be accommodated one after the other transversely to the longitudinal extension of the conveyor belt 30 between two consecutive driver elements 31. The mutually parallel driver elements 31 each have a length which approximately corresponds to a maximum length 32 of the elongate part 2 (as illustrated in FIG. 2 by the larger scale diagram of the elongate part 2).

In another embodiment, the driver elements 31 spaced one apart from the other in the conveying direction—indicated by arrow 9—extend essentially parallel across an entire width 33 of the conveyor belt 30 and the length of these driver elements 31 approximately corresponds to twice the maximum length 32 of the elongate part 2.

Disposed transversely to the longitudinal extension of the conveyor belt 30, the driver elements 31 of both embodiments are provided in the form of transverse bars which project vertically on the width side by a height more or less corresponding to a maximum cross-sectional dimension 34 of the elongate part 2 (as may be seen from the enlarged diagram of the elongate part 2 shown in FIG. 1). The conveyor belt 30 of the first separating mechanism 11 has a width 33 corresponding to at least twice the maximum length 32 of an elongate part 2.

The inlet chute 25 has a chute base 37 extending down at an angle in the direction towards the conveyor belt 30 and two upright chute side walls 38 disposed at an angle to it. The conveyor belt 30 of the belt conveyors, the inclined chute base 37 and the two essentially parallel chute side walls 38 spaced at a distance apart from one another bound a pick-up region 39 with an approximately V-shaped cross-section. A quantity of randomly disposed elongate parts 2 have accumulated in the pick-up region 39.

As may be seen from FIGS. 1 and 2, the conveyor belt 30 extends from the pick-up region 39 as far as a discharge region 40 disposed above it, in particular an ejection point. Disposed between the discharge region 40 of the belt conveyor of the first separating mechanism 11 and a second pick-up region 41 of the second separating mechanism 12 in the direction towards the second pick-up region 41 is a downwardly inclined deflector plate 43, by means of which each elongate part 2 arriving from the discharge region 40 is deflected into the second pick-up region 41 of the second separating mechanism 12. Accordingly, the deflector plate 43 extends across the entire width 33 of the conveyor belt 30.

The supply container 24 in the first pick-up region 39 is equipped with at least one monitoring element 42 in the form of a sensor, for example a photoelectric barrier, an electromagnetic proximity switch or similar, to monitor a filling level in the pick-up region 39. A brief description will be given below of how the first pick-up region 39 is automatically topped up with elongate parts 2.

The elongate parts 2 are delivered to the first inlet conveyor system 10 from supply containers, for example, which are positioned by a Driverless Transport System (DTS) or manually. The elongate parts 2 are picked up and removed from the supply containers by means of a grip, for example, which might be a magnetic grip in the case of metal elongate parts 2 or jaw grips in the case of non-metal elongate parts 2, for example plastic, deposited at a set-down point on the belt conveyor 18 or are emptied out of the supply container directly onto the belt conveyor 18 and then intermittently conveyed to the pick-up region 39. If there is a drop below the desired filling level in the pick-up region 39 of the first separating mechanism 11, the belt conveyor 18 is driven in such a way that elongate parts 2 are delivered to the pick-up region 39 in a random arrangement until the desired filling level is reached or slightly exceeded in the pick-up region 39, after which the belt conveyor 18 is switched off again. This being the case, the elongate parts 2 drop from the belt conveyor 18 onto the inclined chute base 37 and slide in the direction towards the conveyor belt 30 of the first separating mechanism 11 and fill the pick-up region 39 to at least the desired filling level.

As may be seen from FIG. 1, the circulating driver elements 31 or cross-bars move alongside a part quantity or individual elongate parts 2 of the quantity of random elongate parts 2 in the pick-up region 39 in the forward feed direction—indicated by the arrow—and the elongate parts 2 lying against the driver elements 31 are conveyed upwards to the discharge region 40, where they are then ejected due to the deflection of the conveyor belt 30, deflected via the deflector plate 43 and conveyed to the second pick-up region 41 of the second separating mechanism 12. Since the chute base 37 is inclined in the direction towards the conveyor belt 30, the elongate parts 2 automatically slide in the direction towards the conveyor belt 30. As a result, the elongate parts 2 exert a certain amount of contact pressure on the driver elements 31 so that the individual elongate parts 2 can be released and separated from the quantity of randomly arranged elongate parts 2 by the driver elements 31 as they move past.

FIG. 3 illustrates a view in section of the system 1 proposed by the invention incorporating the first separating mechanism 11, the second separating mechanism 12 disposed downstream of the first separating mechanism 11 in the conveying direction—indicated by arrow 9- and, disposed downstream in the conveying direction—indicated by arrow 9—the first discharge unit 13. As described above, only a part quantity of the elongate parts 2 in the first separating mechanism 11 in the first pick-up region 39 is delivered to the second pick-up region 41 of the second separating mechanism 12. A particularly high throughput rate or a particularly high delivery rate of elongate parts 2 to the second separating mechanism 12 can be achieved if a ratio of the number elongate parts 2 in the pick-up region 39, 41 between the first and second separating mechanism 11, 12 is approximately 10:1. There should be a maximum of approximately between 10 and 400 elongate parts 2, in particular 20 and 80 elongate parts 2, for example 30 and 50 elongate parts, supplied in the pick-up region 39 of the first separating mechanism 11. If this ratio is changed to approximately 5:1, the elongate parts 2 will be handled particularly gently during the conveying and separation process in addition to the advantage of obtaining a high throughput or delivery rate to the second separating mechanism 12.

FIGS. 4 and 5 show different views of the second separating mechanism 12 for conveying and separating elongate parts 2 from a part quantity in a conveying direction extending transversely to their longitudinal extension—indicated by arrow 9—which has a supply container 44 with a second inlet chute 45 and an endlessly circulating conveyor element 47 comprising several articulatingly linked driver elements 46 and a frame 48. In order to retain an overall view in FIGS. 4 and 5, only a portion of the conveyor element 47 and the drive elements disposed on either side of it are illustrated. The driver elements 46 are of a strip-shaped design and extend parallel with one another spaced apart by a spacing gap transversely to the conveying direction—indicated by arrow 9—of the elongate parts 2 and transversely to the longitudinal extension of the conveyor element 47.

The inlet chute 45 illustrated in FIGS. 3 and 5 in turn has a chute base 49 angled downwards in the direction towards the conveyor element 47 and two upright chute side walls 50 disposed at an angle thereto. The conveyor element 47 and part regions of the inlet chute 45, such as the inclined chute base 49 and the two parallel chute side walls 50 spaced apart from one another about the chute base 49 bound the second pick-up region 41 with an approximately V-shaped cross-section. A part quantity of pre-separated, random elongate parts 2 from the quantity of random elongate parts 2 from the first separating mechanism 11 has accumulated at the second pick-up region 41.

The part quantity or pre-separated elongate parts 2 from the first separating mechanism 11 drop from the belt conveyor of the first separating mechanism 11 onto the chute base 49 and automatically slide along it in the direction towards the conveyor element 47 and are conveyed by the driven conveyor element 47 from the second pick-up region 41 to a discharge region 51, in particular an ejection point, disposed above the pick-up region 41.

The frame 48 comprises two essentially identical side parts 52 spaced at a distance apart from one another transversely to the conveying direction—indicated by arrow 9- and several cross-members 53 connecting them. The second separating mechanism 12 is releasably connected to the base frame 6 by means of coupling and connecting elements disposed between the frame 48 and the sections 5 of the base frame 6, for example screw connections, centering bolts and similar.

As may be seen by turning to FIGS. 3 to 5, the second separating mechanism 12 has two endlessly circulating drive elements 54 spaced at a distance apart from one another transversely to the conveying direction—indicated by arrow 9—by a distance more or less corresponding to the width of the conveyor element 47 and the conveyor element 47 coupled with them in displacement, as well as a drive 55, for example an electric motor. The drive elements 54 disposed on either side of the conveyor element 47 are provided in the form of a traction means, such as a drive chain, a belt, a cogged belt or similar, for example, and are driven in synchronization. In the embodiment illustrated as an example here, the two drive elements 54 are guided respectively by means of at least one pulley block 56 and drive wheel 57 mounted at each of the side parts 52. The pulley blocks 56 are mounted so as to be freely rotatable, whilst the synchronously driven drive wheels 56 are non-rotatably coupled with one another by a common drive shaft 58. The drive wheels 56 are coupled with one another by means of at least one drive 55.

The drive shaft 58 is coupled with the drive 55 by means of a traction drive. This traction drive has a drive wheel 59 coupled with the drive 55 and a pulley block 60 flange-mounted at the free end of the drive shaft 58, as well as a traction means 61 guided around the drive and pulley block 59, 60, in particular a chain, a cogged belt or similar. The traction drive is covered by a protective housing 62.

The pairs of axially parallel pulley blocks 56 and drive wheels 57 are spaced apart by a vertical distance 63 so that the discharge region 51 above the pick-up region 41, which is at a lower level, and the elongate parts 2 are conveyed by the conveyor element 47 against the effect of gravitational force from the pick-up region 41 to the higher discharge region 51.

As may be seen by comparing FIGS. 6 and 7, each drive element 54, in particular the drive chain, is guided along a slide track 65 disposed at each side part 52 of the frame 48 and extending between the pulley block and drive wheel 56, 57 in the region of its strand 64 directed towards the second pick-up region 41. As illustrated on an enlarged scale in FIG. 7, this slide track 65 is expediently provided in the form of a slot bounded by two oppositely lying guide surfaces 66 on two plate segments 67, 68 disposed in a plane. The plate segments 67, 68 are each releasably connected to the side part 52 of the frame 48 and in particular are screwed thereto. The drive element 54 extends through the slot and is supported on the oppositely lying guide surfaces 66 of the slide track 65. If, as illustrated in the preferred embodiment, the drive element 54 is provided in the form of a roller chain comprising chain links 70 articulatingly linked to one another by bolts 69 extending parallel with one another, the rollers 71 rotatably mounted on the bolts 69 slide on the guide surfaces 66. Consequently, each drive element 54 is forcibly guided in the direction perpendicular to the guide surfaces 66 across the length of the slide track 65. The slide track 65 extends between the pulley block and wheel 56, 57 across a part length of the strand 64 of the drive element 54 directed towards the second pick-up region 41 and has a width 73 extending transversely to the feed direction of the drive element 54 bounded by the guide surfaces 66, which, if the drive element 54 is provided in the form of a cogged belt, essentially corresponds to a thickness thereof or, if a roller chain is used, essentially corresponds to a diameter of the roller 71.

A lateral guide of every drive element 54, in particular a roller chain, is provided by means of the link plates 72 of every chain link 70 projecting laterally from the plate segments 67, 68. To ensure that the drive element 54 is not damaged as it is pulled through the slide track 65, an inlet region of the slide track 65 adjacent to the chute base 49 and the pulley block 56 is of an essentially conical design, the guide surfaces 66 of which taper to the width 73 in the direction of an outlet region lying opposite the inlet region in the feed direction of the drive element 54. By means of the conically tapered inlet region of the slide track 65 in the feed direction of the drive element 54, the drive element 54 can be automatically centered with respect to the slide track 65 as it is pulled through the slide track 65.

The first guide surface 66 of the first plate segment 67 disposed on the internal face of the drive element 54 lying opposite the pick-up region 41 projects out from the first end face 74 formed at the inlet region and extends between the first end face 74 and an engagement surface 75 of the pulley block 56 for the drive element 54, constituting the convexly curved arcuate surface directed towards the pick-up region 41. In this preferred embodiment, the pulley block 56 is provided in the form of a sprocket wheel and the engagement surface 75 is provided in the form of external toothing.

For practical purposes, an outlet region of the slide track 65 farther away from the chute base 49 and the pulley block 56 is of an essentially conical design and its guide surfaces 66 diverge in the direction of a second end face 76 lying opposite the first end face 74 in the feed direction of the drive element 54. Between the inlet and outlet region, the guide surfaces 66 expediently run parallel with one another. The guide surfaces 66 extending between the first end face 74 in the inlet region and a second end face 76 in the outlet region therefore run in a concavely curved arcuate surface directed towards the pick-up region 41.

Starting from the second end face 76 in the outlet region, the guide surface 66 directed towards the pick-up region 41 runs in a straight line in the direction towards the free end of the first plate segment 67. The second plate segment 68 adjacent to the pick-up region 41 bounds a length of the slide track 65 by means of its parallel end faces 74, 76 and the slide track 65 is disposed across only a part length of the strand of the respective drive element 54 guided by it.

As may also be seen from FIGS. 6 and 7, a third plate segment 77 is provided between the first plate segment 67 and the drive wheel 57, connected to the frame 48, in particular to the respective side part 52, which forms a guide surface 78 adjoining the guide surface 66 of the first plate segment 67 without interruption, on the narrow side lying opposite the chute base 49 and the drive wheel 57, and extending to just in front of the drive wheel. This guide surface 78 extends in a convexly curved arrangement in the part section closer to the first plate segment 67, directed towards the pick-up region 41 and then in a straight line, in particular parallel with a horizontal plane 79. The drive element 54 is supported on the guide surface 78. If, as is the case in a preferred embodiment, the drive element 54 is provided in the form of a roller chain, the rollers 71 rotatably mounted on the bolts 69 roll on the guide surface 78 and the link plates 72 projecting from either side of the third plate segment 77 provide a reliable guiding action for the roller chain.

What, in particular, is a return strand 80 of every drive element 54, in particular the roller chain, disposed between the pulley block and wheel 56, 57 lying opposite the pick-up region 41 is guided on a convexly curved guide surface 81 of a support plate 82 secured to the frame 58, in particular to the respective side parts 52, directed towards the pick-up region 41. The drive element 54 is supported on the guide surface 81 of the respective support plate 82 by means of its link plates 72.

As may also be seen from FIGS. 3 and 4, a mechanically operated tensioning unit 83 is disposed between each pulley block 56 and the frame 48, in particular the respective side part 52.

The drive elements 54, synchronously drive in the feed direction—indicated by arrow 84- and the driver elements 46 displacingly coupled with the individual chain links 70 are guided so that they follow the course of the guide surfaces 66, 77, 81 along a displacement path and are deflected at the pulley block and wheel 56, 57 and at the slide track 65. Accordingly, the same movement is imparted to the conveyor element 47 as the drive elements 54 disposed on either side of the conveyor element 47.

As illustrated in FIG. 6, one strand of the conveyor element 47 comprising a plurality of articulatingly linked driver elements 46 adjacent to the pick-up region 41 and extending between it and the discharge region 51, in particular a pulled strand, is divided into a driving portion 85, a separating region 86 and a discharge portion 87. These are disposed immediately one after the other and adjacent to one another in the conveying direction—indicated by arrow 9. The driving portion 85 essentially extends across the length of the slide track 65 bounded by the end faces 74, 76 and runs in an approximately concavely curved arrangement directed towards the pick-up region 41, whereas the separating region 86 disposed downstream in the feed direction—indicated by arrow 84—extends in an essentially straight line across wide parts and at an angle of inclination 88 by reference to the horizontal plane 79 indicated by broken lines. The angle of inclination 88 of the separating region 86 is smaller than 90° and is preferably between 60° and 85°, in particular between 70° and 80°, for example 75°. An angle 89 subtended by a tangent “T” at the apex point “S” of the concave driving portion 85 and a chute base 49 of the inlet chute 45 is less than 90°, in particular between 60° and 80°, for example 75°. Accordingly, the length of the driving portion 85 is essentially bounded by the length of the slide track 65.

In the driving portion 85, the driver elements 46 move past individual elongate parts 2 of the elongate parts 2 pre-separated from the part quantity building up in the pick-up region 41 and the latter are picked up in a recessed groove 90 with an approximately trapezoidal cross-section, which will be described in more detail below, and conveyed upwards to the discharge region 51.

The inclined separating region 86 is provided for the situation where two or more elongate parts 2 are stuck together and/or become hooked in one another, as can easily happen if the elongate parts 2 have an asymmetrical part geometry as illustrated in FIGS. 1 and 2, and a passing driver element 46 picks them up and carries them upwards, because the shift in the center of gravity of these stuck and/or hooked elongate parts 2 away from the recessed groove 90 causes them to be returned, in particular dropped, back into the pick-up region 41. This ensures that the elongate parts 2 are reliably separated from the part quantity in the pick-up region 41 in a conveying direction—indicated by arrow 9 extending transversely to the longitudinal extension of the elongate parts 2.

The discharge portion 87 disposed immediately downstream in the conveying direction—indicated by arrow 9—essentially extends in a straight line across wide parts and parallel with the horizontal plane 79. The discharge region 51 is disposed in the deflecting region of the conveyor element 47, from which the separated elongate parts 2 are delivered via a drop shaft 91 to the first discharge unit 13.

As also illustrated in FIGS. 3 and 4, a deflector plate 92 is disposed above the conveyor elements 47, which is inclined downwards by reference to the horizontal plane 79. This deflector plate 92 extends between the two chute side walls 50 and the elongate parts 2 are deflected as they drop from the first separating mechanism 11, possibly via the deflector plate 92, down into the pick-up region 41 or the region of the driving portion 85. As a result, the already separated elongate parts 2 are conveyed without disruption along the separating and discharge portion 86, 87. As also illustrated, upright side walls 9 extending parallel with the driver elements 46 run between the two mutually spaced chute side walls 50 and bound or form the supply container 44 in conjunction with the inlet chute 45. To enable the separating mechanisms 11, 12 to be positioned relative to one another, the first separating mechanism 11 is mounted so that it can be displaced by means of two linear guides 94 on the base frame 6 and moved in the direction towards and away from the second separating mechanism 12.

FIGS. 8 and 9, which will be described together, illustrate a portion of the conveyor element 47 with the driver elements 46 and the drive elements 54 disposed on either side of them, in particular drive chains. The drive chains are formed by chain links 70 articulatingly linked to one another by means of bolts 69 extending parallel, each being guided over the at least one pulley block 56 and at least one drive wheel 57 (as illustrated in FIGS. 4 and 7). These drive chains are respectively formed by a roller chain with connecting plates 95 and are disposed transversely to the conveying direction of the elongate parts 2—indicated by arrow 9—at a distance from one another and in mirror image with respect to one another by reference to a vertical longitudinal mid-plane 96 of the conveyor element 47. Each of the connecting plates 95 is attached to a linking plate 97, in particular screwed or riveted, by means of at least a first connecting element. The driver elements 46 extending between the oppositely lying drive chains are releasably secured to a strip-type support plate 98 by means of at least a second connecting element, in particular a screw, rivet, catch and/or snap-fit connection. The support plate 98 is releasably connected by its ends to the linking plates 97 disposed at a distance from one another in the conveying direction—indicated by arrow 9- and in pairs in a plane extending transversely to the conveying direction—indicated by arrow 9—by means of connecting elements.

As illustrated on a larger scale in FIG. 9, a spacing gap 99 is formed between two driver elements 46 disposed one after the other in the conveying direction—indicated by arrow 9—which is bounded by two oppositely lying flat, mutually parallel longitudinal edges 100 of immediately consecutive driver elements 46 and is smaller than the minimum cross-sectional dimension 34 of the elongate part 2 (as illustrated in FIG. 1). The longitudinal edges 100 are disposed symmetrically with respect to an articulation axis 101 of two articulatingly linked chain links 70. Alternatively, the driver elements 46 could also be connected directly to the linking plates 97 lying opposite one another in mirror image by reference to the longitudinal mid-plane 96, in which case the support plates 98 can be dispensed with.

FIGS. 10 to 12, which will be described together, are views in cross-section illustrating different embodiments of the driver elements 46 of the conveyor element 47, the driver element 46 of the embodiment illustrated in FIG. 10 being particularly suitable for elongate parts 2 with an asymmetrical cross-section, whilst the driver elements 46 of the embodiments illustrated in FIGS. 11 and 12 are used for elongate parts 2 with a symmetrical cross-section. All the driver elements 46 of the conveyor element 47 are of an identical design and each has at least one recessed groove 90 with an approximately trapezoidal cross-section extending in its longitudinal direction. The recessed groove 90 expediently extends continuously and across almost the entire length 102 of the driver element 46 (as illustrated in FIG. 8) and is bounded by a groove base 104 extending essentially parallel with a mounting surface directed towards the drive elements 54 and guide surfaces 105 extending at an angle towards one another. The planes of the two guide surfaces 105 subtend an angle 106 of less than 90° and in particular between 20° and 60°, for example 30°. The length 102 of the driver elements 46 defines the width of the conveyor element 47.

The recessed groove 90 has a length corresponding to at least twice the maximum length 32 of the elongate part 2. Consequently, at least two elongate parts 2 can be accommodated in the recessed groove 90 of a driver element 46 one after the other in its longitudinal extension. Alternatively, the length of the recessed groove 90 may correspond to a multiple of the maximum length 32 of the elongate parts 2, in which case three or four elongate parts 2 can be accommodated one after the other in its longitudinal extension.

Every driver element 46 of the conveyor element 47 has an approximately C-shaped cross-section, a base 107 adjacent to the drive elements 54 or drive chains base 107 and two legs 108 extending out from the base 107.

The driver element 46, in particular the first and second legs 108, form narrow sides 109 lying opposite one another in the conveying direction—indicated by arrow 9- and extending at an angle towards one another, which diverge starting from the free ends of the first and second legs 108 in the direction towards the mounting surface 103. The advantage of this design is that even when using small pulley blocks for the conveyor element 47, the driver elements 46 disposed one after the other in the conveying direction—indicated by arrow 9—do not collide with one another.

The front first leg 108 in the conveying direction—indicated by arrow 9—projects in the conveying direction—indicated by arrow 9—with its free end beyond the rear second leg 108 and forms a deflector surface 110 at its free end, inclined towards the groove base 104. The groove base 104 and the deflector surface 110 subtend an angle of less than 90°, in particular between 10° and 60°, for example 30°.

A minimum depth 111 of the recessed groove 90 is at least slightly bigger than a maximum normal distance 112 measured between the groove base 104 and a surface center of gravity 113 of the individual elongate part lying in the cross-sectional planes. A maximum depth 111 of the recessed groove 90 more or less corresponds to the maximum cross-sectional dimension 34 of the elongate part 2. A minimum width 114 of the recessed groove 90 is at least slightly bigger than a maximum cross-sectional dimension 34 of the elongate part 2 and/or more or less corresponds to the maximum cross-sectional dimension 34 of the elongate part 2. However, a maximum width 114 of the recessed groove 90 is smaller than twice the minimum cross-sectional dimension 34 of the elongate part 2. These dimensions ensure that the recessed groove 90 of a driver element 46 always accommodates only a single elongate part 2 ever, as viewed in the cross-sectional plane. Solely due to the geometry of the recessed groove 90 as the driver elements 46 move past the randomly arranged elongate parts 2 in the pick-up region 41, only a single elongate part 2 is usually picked up from the part quantity, resulting in optimum separation at a simultaneously high removal rate of separated elongate parts 2 at the second separating mechanism 12.

FIG. 11 illustrates a different embodiment of the driver element 46 with the elongate part 2 accommodated in the recessed groove 90, which has the shape of a rod-type circular section which may have different cross-sectional dimensions 34.

FIG. 12 illustrates another embodiment of the driver element 46 with the elongate part 2 accommodated in the recessed groove 90, which is a section with a cross-section of a clover leaf shape.

The structure of the driver element 46 illustrated in FIGS. 11 and 12 essentially corresponds to the structure illustrated in FIG. 10. With these embodiments, both the first and the second leg 108 are of identical height because, unlike when conveying asymmetrical elongate parts 2—as illustrated in FIG. 10—when conveying symmetrical elongate parts 2—as illustrated in FIGS. 11 and 12—separated elongate parts 2 picked up from the separating region 86 (see FIG. 3) dropping down in the direction of the driving portion 85 (see FIGS. 3 and 6) can not become hooked on elongate parts 2 accommodated in the recessed groove 90.

FIG. 13 is a side view in section illustrating another embodiment of the second separating mechanism 12 for conveying and separating elongate parts 2 from a part quantity in a conveying direction—indicated by arrow 9—extending transversely to their longitudinal extension. In order to improve clarity, the elongate parts 2 are not illustrated. The separating mechanism 12 has a supply container 44 with the second inlet chute 45 and an endlessly circulating conveyor element 46 comprising a plurality of articulatingly linked driver elements 46, as well as a frame 48.

The inlet chute 45 in turn comprises the chute base 49 downwardly inclined in the direction towards the conveyor element 47 and two upright chute side walls 50 extending at an angle. The conveyor element 47, the inclined chute base 49 and the two mutually parallel chute side walls 50 spaced at a distance apart from one another bound the second pick-up region 41 with a more or less V-shaped cross-section. A strand, in particular a pulled strand, of the conveyor element 47 adjacent to the pick-up region 41 and extending between it and the discharge region 51 is divided into the driving portion 85, the separating region 86 and the discharge portion 87. In this embodiment, the driving portion 85 is formed as an extension of the separating region 86 and runs in an essentially straight line and the angle of inclination 88 subtended with the horizontal plane 79 indicated by a broken line is less than 90°, preferably between 60° and 85°, in particular between 70° and 80°, for example 75°. The discharge portion 87 disposed immediately after the separating region 86 in the in conveying direction—indicated by arrow 9—extends in a straight line across wide parts and parallel with the horizontal plane 79. The discharge region for the separated elongate parts 2 is disposed in the deflecting region of the conveyor element 47.

Again in this embodiment, the conveyor element 47 is displacingly coupled with drive elements 54 disposed on either side of it, in particular drive chains, drive belts etc. Each of the two drive elements 54 or each of the two drive chains is in turn supported on guide surfaces 66, 78, not illustrated, on a first and third plate segment 67, 77, and in particular the rollers 71 of the drive chain roll on the guide surfaces 66, 78. The guide surface 66 directed towards the pick-up region 41 extends in a straight line or flat and at an angle with respect to the horizontal plane 79. The structure and function of the second separating mechanism 12 was described above in detail and this part of the description may be applied to this embodiment.

FIG. 14 is a highly simplified diagram showing a side view in section of another embodiment of the second separating mechanism 12 for conveying and separating elongate parts 2 from a part quantity in a direction extending transversely to the conveying direction—indicated by arrow 9. In order to retain clarity in the drawings, the elongate parts 2 are not illustrated. The conveyor element 47 in this embodiment is provided in the form of an endless conveyor belt, in particular a traction means such as a belt, which is directly guided by means of at least one pulley block 56 and at least one drive wheel 57. This conveyor belt has driver elements 46 on an external face directed towards the pick-up region 41 which are integrally joined to the conveyor belt in particular. On its external face directed towards the pick-up region 41, every driver element 46 at least one recessed groove 90 extending across at least a part of the width of the conveyor belt and open in the direction towards the pick-up region 41 with an approximately trapezoid-shaped cross-section. A length of the recessed groove 90 corresponds to at least twice the maximum length 32 of the elongate part 2 (see FIG. 2). The driver elements 46 and recessed grooves 90 extend parallel with one another and transversely to the conveying direction—indicated by arrow 9—of the elongate parts 2. Accordingly, at least two elongate parts 2 can be accommodated in the recessed groove 90 of a driver element 46 in its longitudinal direction, one after the other in the direction extending transversely to the conveying direction—indicated by arrow 9.

The recessed groove 90 is bounded by the groove base 104 and the guide surfaces 105 extending at an angle with respect to one another and the planes of the two guide surfaces 105 subtend the angle 106 which is smaller than 90°. The angle 106 is between 20° and 60° in particular, for example 30°.

In the embodiment illustrated in FIG. 14, the driveable conveyor belt is disposed on an internal face directed towards the pulley block and wheel 56, 57 with a flat engagement surface 115 supported on the guide surfaces 66, 78, 81 of the plate segments 67, 77 and support plate 82, not illustrated, and is guided along them and deflected on the pulley block and wheels 56, 57. The pulley block and wheel 56, 57 are provided in the form of roller-type belt discs. In another embodiment, the engagement surface 115 is provided with a section, in particular toothing, and the teeth mesh in the respective tooth gaps of the pulley block and wheels 56, 57 provided in the form of toothed discs, thereby resulting in a positive connection. Similarly, tension elements made from steel or glass fibers, aramide fibers or similar may be provided across the entire belt width, although this is not illustrated.

The pulled strand of the conveyor element 47 adjacent to the pick-up region 41 and extending between it and the discharge region 51 is divided into the driving portion 85, separating region 86 and discharge portion 87. In this embodiment, the driving portion 85 is disposed in an essentially straight line in the extension of the separating region 86 and the angle of inclination 88 with respect to the horizontal plane 79 is less than 90°, preferably between 60° and 85°, in particular between 70° and 80°, for example 75°. The discharge portion 87 downstream adjacent to the separating region 86 extends across large parts in an essentially straight line and parallel with the horizontal plane 79. Alternatively, as is the case with the drawings described above, the driving portion 85 may also be provided with a concavely curved, in particular arcuate design directed towards the pick-up region 41.

A brief description will be given below, explaining how the elongate parts 2 are conveyed from the second separating mechanism 12 to the first discharge unit 13. The part quantity of randomly arranged elongate parts 2 intermittently conveyed from the first separating mechanism 11 into the pick-up region 41 of the second separating mechanism 12 is essentially totally separated into individual elongate parts 2 by the second separating mechanism and delivered via the drop shaft 91 to the first discharge unit disposed downstream in the conveying direction—indicated by arrow 9. As illustrated in FIGS. 4 and 5, the second separating mechanism 12 in the second pick-up region 41 is equipped with at least one monitoring element 116 in the form of a sensor, for example an optical light sensor, electromagnetic proximity switch, or similar, for monitoring a filling level in the second pick-up region 41. When the filling level in the second pick-up region 41 is exceeded, the first inlet conveyor system 111 is driven so that a part quantity of elongate parts 2 is delivered to the second pick-up region 41 until the desired filling level in the second pick-up region 41 is reached or slightly exceeded, after which the first separating mechanism 11 is switched off if necessary. The elongate parts 2 then drop from the belt conveyor of the first separating mechanism 11 onto the inclined chute base 49 and slide in the direction of the conveyor element 47 of the second separating mechanism 12 and fill the pick-up region 41 to at least the desired filling level. As also illustrated in FIG. 4, the second separating mechanism 12 is also provided with two monitoring elements 117 in the discharge region 51 in the form of optical sensors, for example photoelectric barriers, electromagnetic proximity switches or similar, for monitoring whether the recessed groove 90 is occupied by one or two elongate parts 2 etc. The monitoring elements 117 are disposed close to the edges of the endless conveyor element 47 and on either side of it.

The separated elongate parts 2 conveyed upwards at the discharge region 51 drop down onto the conveyor belt of the first discharge unit 13 and are conveyed to the orienting mechanism 14 for the separated elongate parts 2 disposed downstream in the conveying direction—indicated by arrow 9.

FIGS. 15 to 17, which will be described together, are highly simplified diagrams illustrating different views of a part region of the first and second discharge units 13, 15 and the orienting mechanism 14 disposed between them. The first discharge unit 13 is disposed upstream of the orienting mechanism 14 as viewed in the conveying direction—indicated by arrow 9—whilst the second discharge unit 15 is disposed downstream of the orienting mechanism 14. The two discharge units 13, 15 comprise the belt conveyors 19 described above and are supported on a standing surface 8, not illustrated, by means of a support frame 20. A conveying direction indicated by arrow 9—extends alongside the orienting mechanism 14, parallel with the longitudinal extension of the elongate parts 2.

The orienting mechanism 14 comprises a frame 118 and at least one driveable conveying and orienting element. The frame 118 is mounted on a support frame 121 made from sections 120 and has two vertically projecting side frame parts 122 disposed at a distance apart from one another transversely to the conveying direction—indicated by arrow 9—of the elongate parts 2 and a support plate 123 connected to them. To retain clarity in FIG. 15, the front side frame part 122 is not illustrated. The frame 118 is connected to its support plate 123 by means of schematically illustrated connecting elements, such as screws, being supported on the sections 120 and releasably connected to the support frame 121.

The conveying and orienting element forms a shaft-type conveyor passage 124, the crosssectional dimension of which becomes smaller staring from an inlet region 125 in the direction towards an outlet region 126. The conveyor passage 124 is bounded by two conveyor surface portions 128 tapering in the direction towards a vertical longitudinal mid-plane 127 of the conveyor passage 124 extending between the parallel side frame parts 122.

In this preferred embodiment, the conveying and orienting element is provided in the form of a plurality of conveying and orienting rollers 129, 130 disposed at a distance 131 apart from one another in a horizontal plane between the inlet region 125 disposed closer to the first discharge unit 13 and the outlet region 126 disposed closer to the second discharge unit 15. Also disposed in the inlet region 125 upstream of the first conveying and orienting roller 129 in the conveying direction—indicated by arrow 9—is at least one inlet roller 132. The conveying and orienting rollers 129, 130 as well as the inlet roller 132 are each mounted so as to be rotatable about a rotation axis 133 oriented perpendicular to the side frame parts 122 and each has a radially extending narrow region 134 bounded by the conveyor surface portions 128 in a mid-portion by reference to their longitudinal extension. The conveying and orienting rollers 129, 130 are rotationally symmetrical by reference to the rotation axis 133 and have the shape of an egg timer and are preferably made from plastic. By preference, there are four conveying and orienting rollers 129, 130 in the inlet region 125 and five in the outlet region 126. The inlet roller 132 is preferably also made from plastic.

The narrow region 134 in this embodiment is bounded by a concavely rounded conveyor surface 135 made up of the conveyor surface portions 128 disposed symmetrically with respect to the longitudinal mid-plane 127 and forms an approximately U-shaped or semi-circular contour. In particular, the conveyor surface 135 of the conveying and orienting rollers 129, 130 is provided in the shape of a semi-circular arc. This being the case, a radius 136 of the conveyor surface 135 or concavely rounded narrow region 134 in the conveying and orienting rollers 129 in the inlet region 125 is bigger than a radius 137 of the conveyor surface 135 or concavely rounded narrow region 134 in the conveying and orienting rollers 130 in the outlet region 126. The radius 136 of the narrow region 134 of the conveying and orienting rollers 129 in the inlet region 125 expediently more or less corresponds to the maximum cross-sectional dimension 34 of the elongate part 2, at most 0.8-times to 1.3-times the maximum cross-sectional dimension 34 of the elongate part 2. The radius 137 of the narrow region 134 of the conveying and orienting rollers 130 in the outlet region 126 is expediently smaller than the maximum cross-sectional dimension 34 of the elongate part 2 and is at most 0.5-times to 0.8-times the maximum cross-sectional dimension 34 of the elongate part 2. The conveyor surface 135 of the inlet roller 132 has the shape of a hyperbola or is concavely rounded and a radius of curvature or a radius 138 of the narrow region 134 is bigger than the radius 136, 137 of the conveying and orienting rollers 129, 130 disposed in the inlet and outlet region 125, 126.

In another embodiment of the narrow region 134 in the conveying and orienting roller 129, 130 schematically illustrated in FIG. 17 and the inlet roller 132, not illustrated, the latter is bounded by a polygonal conveyor surface 135 made up of the flat conveyor surface portions 128 inclined symmetrically with respect to the longitudinal mid-plane 127 and a more or less V-shaped or trapezoidally shaped contour. The planes of two oppositely lying conveyor surface portions 128 subtend an angle 139 of between 90° and 120°, and the longitudinal mid-plane 127 bisects the angle 139 subtended by the conveyor surface portions 128. The inclined conveyor surface portions 128 diverge, starting from the rotation axis 133, in the radial direction of the conveying and orienting rollers 129, 130 and inlet roller 132. The conveying and orienting rollers 129, 130 and inlet roller 132 are formed by a rotationally symmetrical body by reference to the rotation axis 133, essentially comprising two complementary frustoconical bodies conically tapering towards one another. A cylindrical transition region 140 spaces the two frustoconical bodies apart from one another in the region of their smaller cross-sectional dimension, which is cylindrical or rounded by reference to the rotation axis 133. In this embodiment, the angle 139 subtended between two conveyor surface portions 128 of the conveying and orienting rollers 129 lying opposite one another transversely to the conveying direction—indicated by arrow 9—in the inlet region 125 is bigger than the angle 139 between two conveyor surface portions 128 of the conveying and orienting rollers 130 in the outlet region 126 lying opposite one another transversely to the conveying direction—indicated by arrow 9.

The radius 136 or angle 139 of the narrow region 134 on all conveying and orienting rollers 129 in the inlet region 125 is identical. Likewise, the radius 137 or angle 139 of the narrow region 134 on all conveying and orienting rollers 130 in the outlet region 126 is identical. The conveyor surface 135 forms an external surface and the contoured narrow region 134 is disposed in the external surface. The cross-sectional dimension of the conveyor passage 124 is respectively bounded by the conveyor surface 135 of the conveying, orienting and inlet rollers 129, 130, 132 in the inlet and outlet region 125, 126.

As illustrated in FIG. 15, a longitudinal distance 141 between the rotation axis 133 of the elongate part 2 in the inlet region 125 in the conveying direction—indicated by arrow 9—corresponds to the inlet roller 132 upstream of the first conveying and orienting roller 129 and the rotation axis 133 of the elongate part 2 in the outlet region 126 in the conveying direction—indicated by arrow 9—of the last conveying and orienting roller 130 more or less corresponds to the maximum length 32 of the elongate part 2. The conveying, orienting and inlet rollers 129, 130, 132 are disposed in a row at a slight distance 131 one after the other in the conveying direction—indicated by arrow 9.

As illustrated more clearly in FIG. 16, at least one bolt-type deflector element 142 is disposed respectively between two consecutive conveying, orienting and inlet rollers 129, 130, 132, which has a deflector surface 134 on its end face directed towards the elongate part 2 conveyed by the conveying, orienting and inlet rollers 129, 130, 132 exclusively by frictional force, slightly below the conveyor surface 135, more or less conforming to the same contour as the narrow region 134. The deflector surface 143 of the first embodiment of the conveying, orienting and inlet rollers 129, 130, 132 is concavely rounded and its radius corresponds to the radius 136, 137, 138 of the conveying, orienting and inlet rollers 129, 130, 132. These deflector elements 142 are mounted so as to be stationary on the support plate 123 of the frame 118 with the end face directed away from the conveyed elongate part 2 and their longitudinal axes respectively extend vertically with respect to the support plate 123.

A horizontal conveying plane of the orienting mechanism 14 intersecting the apex of the arcuate conveyor surfaces 135 or extending at a tangent to the transition region 140 is disposed flush with the conveying planes of the two discharge units 13, 15.

The individual conveying, orienting and inlet rollers, 129, 130, 132 are coupled via a drive mechanism with at least one drive motor 147. The drive mechanism in this embodiment is provided in the form of a gear, in particular a toothed gear. The conveying, orienting and inlet rollers 129, 130, 132 are drivingly inter-connected by means of driven and driving gears 144, 145 and are drivingly connected via a central drive wheel 146 to the drive motor 147. The drive wheel 146 and the gears 144, 145 are provided in the form of mutually meshing gears. Naturally, gears of any type may be used, such as traction gears, chain gears and similar, for example.

As may be seen from the plan view illustrated in FIG. 16, the conveying, orienting and inlet rollers, 129, 130, 132 are each connected to a drive shaft 148 with which they fixedly rotate. The drive shafts 148 are mounted by means of bearings, not illustrated, on the oppositely lying side frame parts 122 and each is fitted with a gear 144 at its free end facing the drive motor 147, which is axially secured by means of a locking element 149. Disposed between the two drive shafts 148 of the conveying, orienting and inlet rollers 129, 130, 132 in the side frame part 122 disposed closer to the drive motor 147 are drive shafts 151 on bearings, not illustrated, mounted so as to rotate about a rotation axis 150 oriented perpendicular to the side frame parts 122. At their free end directed towards the drive motor 147, each of these is provided with a gear 145. A gear 145 simultaneously meshes in two gears 144 of two adjacently lying conveying, orienting and inlet rollers, 129, 130, 132.

In another embodiment of the drive mechanism or gear, not illustrated, a belt gear is provided. In this instance, a drive roller is rigidly connected to every conveying, orienting and inlet roller 129, 130, 132, in particular is integrally formed therewith, which is separate from the narrow region 134 and has a radially extending recessed groove. A belt is guided in the groove. In the region between two adjacently lying drive rollers of the conveying, orienting and inlet rollers 129, 130, 132, the belt is deflected outwards by a contact roller and drive rollers and surrounds them at an angle of approximately 20°. The belt is driven by the drive wheel 146 coupled with the drive motor 147 and fed around the drive rollers. The conveying, orienting and inlet rollers 129, 130, 132 are thus drivingly connected to one another and to the drive wheel 146 by means of the belt.

In another embodiment of the conveying and orienting element, not illustrated, it has at least two endlessly circulating traction means, in particular belts. The first traction means is disposed in the inlet region 125 and the second traction means is disposed in the outlet region 126 and they form a conveyor surface 135 comprising at least two lateral conveyor surface portions 128 symmetrically inclined towards one another with respect to the longitudinal mid-plane 127 and a base-side conveyor surface portion 128 extending between them. As viewed in the cross-sectional plane extending transversely to the conveying direction—indicated by arrow 9—the two lateral conveyor surface portions 128 facing one another diverge from the bottom up respectively at an angle of 60 with respect to the longitudinal mid-plane 127 in the inlet region 125 and at an angle of 45 with respect to the longitudinal mid-plane 127 in the outlet region 126, so that the conveyor passage 124 has an approximately trapezoidally shaped cross-section and the cross-sectional dimension in the inlet region 125 is bigger than the cross-sectional dimension in the outlet region 126. The longitudinal mid-plane 127 constitutes the angle bisection of the angle subtended by the two lateral conveyor surface portions 128. The cross-sectional dimension is expediently continuously constant across the length of the inlet and outlet region 125, 126. In the inlet region 125, the cross-sectional dimension is bigger than the cross-sectional dimension in the outlet region 126. The traction means are driven synchronously and in the same direction.

Alternatively, the conveying and orienting element may also be provided in the form of endlessly circulating traction means, such as belts, lying opposite one another at a distance apart, transversely to the conveying direction—indicated by arrow 9—in the inlet and outlet region 125, 126 respectively, which at least partially form the lateral conveyor surface portions 128 with their belt surfaces directed towards the conveyor passage 124 and are synchronously driven. The base-side conveyor surface portion 128 in this embodiment is provided in the form of a third traction means, in particular a belt, which extends across a width corresponding to the distance between the lateral conveyor surface portions 128 and across the length of the conveyor passage 124 with the trapezoidal cross-section. All the traction means are driven synchronously and in the same direction.

The conveyor passage 124 is bounded by the lateral conveyor surface portions 128 of the pairs of traction means symmetrically inclined with respect to the longitudinal mid-plane 127 in the inlet and outlet region 125, 126 and a base-side conveyor surface portion 128, and the lateral conveyor surface portions 128 are flat or concave facing the conveyor passage 124 and the base-side, essentially horizontal conveyor surface portion 128 is concavely rounded or flat.

The way in which the orienting mechanism 14 operates will now be described below. Once the elongate parts 2 have been conveyed out of the second separating mechanism 12 to the first discharge unit 13, they are delivered to the orienting mechanism 14.

The orienting mechanism 14 proposed by the invention is based on the knowledge that the individual elongate part 2 with an asymmetrical external contour and eccentrically lying center of gravity tips slightly about a longitudinal edge parallel with the conveying direction—indicated by arrow 9- and remains in a predefined position of readiness. The tilting effect about the longitudinal edge of the elongate part 2 is reliably produced by the conveyor surface 135.

As illustrated in the drawings, the asymmetrical elongate part 2 has on one of its side faces two arms spaced at a distance apart from one another in its longitudinal extension and laterally projecting from a base body. If the elongate part 2 is delivered to the orienting mechanism 14 incorrectly positioned in terms of its position of readiness, it is automatically tipped about its longitudinal edge lying opposite the arms into the correctly oriented position of readiness with respect to the position of its center of gravity as it is fed forward in the conveying direction—indicated by arrow 9—by means of the projecting arms running on a conveyor surface portion 128 of the conveyor surface 135. The separated and correctly oriented elongate part 2 is then delivered to the second discharge unit 15 disposed downstream in the conveying direction—indicated by arrow 9.

By contrast, when the separated elongate part 2 is transferred from the first discharge unit 13 of the orienting mechanism 14 in the correctly oriented, predefined position of readiness, the correctly oriented elongate part 2 is gated through the orienting mechanism 14 unchanged and is conveyed in the correct position by reference to the center of gravity of the elongate part 2 to the second discharge unit 15.

Correctly oriented in its gravitational position, the elongate part 2 is fed way from the orienting mechanism via the other discharge unit 15. As illustrated in the block diagram of FIG. 2, at least one camera system 153, in particular a scanner, CCD camera (Charge-Coupled Device Camera) is provided in the region of the second discharge unit 15, with the aid of which the elongate part 2 is detected as it passes by. On the basis of the detected image data, a verification or a desired-actual comparison can now be run in an electronic control unit. If any damage is detected on the elongate part 2 or it is detected as a foreign part, it is gated away by means of a gating-out system, not illustrated, for example by means of a flow of compressed air directed transversely to the conveying direction—indicated by arrow 9- or a displaceable mechanical jaw disposed transversely to the conveying direction—indicated by arrow 9—into a discarded parts container 154 disposed at the side, adjacent to the second discharge unit 15.

If an elongate part 2 fed past the camera system 153 is not correctly oriented, in particular the front and rear ends are turned by 180°, this incorrectly oriented elongate part 2 is gated out at the gating-out device and conveyed via a chute 155 extending between the discharge unit 15 and the first separating mechanism 11 into the pick-up region 39 or the inlet chute 25 of the first separating mechanism 11. Consequently, elongate parts 2 that have been separated and which are in the correct gravitational and spatial position meeting the sorting criteria are fed to the buffer run 16 disposed downstream of the second discharge unit 15 in the conveying direction—indicated by arrow 9. The individual elongate part 2 is also picked up by a first handling device 156 disposed in the end region of the buffer run 16 remote from the discharge unit 15 and transferred in essentially the correct position to a second handling device 157, after which it is in turn placed on the second inlet conveyor system 17 and conveyed to a removal position at its end lying opposite the second handling device 157. The elongate part 2 is then picked up at the removal position by a gripper of the assembly and processing unit 3 and delivered to an assembly process for assembling a component, for example.

FIG. 18 is a highly simplified diagram illustrating a side view of a partial portion of another embodiment of the system 1 proposed by the invention for conveying, separating and orienting elongate parts 2. The system 1 comprises a schematically illustrated first inlet conveyor system 10, a first and second separating mechanism 11′, 12′ adjoining it respectively in the conveying direction—indicated by arrow 9—, the first discharge unit 13 disposed downstream of the second separating mechanism 12′ in the conveying direction—indicated by arrow 9—, the orienting mechanism 14 disposed downstream of it, not illustrated in this diagram, the second discharge unit 15, buffer run 16 and second inlet conveyor system 17 to the assembly and processing unit 3. Disposed at an offset of 90° from the first separating mechanism 11, the first inlet conveyor system 10, in particular the belt conveyor 18, extends as far as the pick-up region 39′ of the first separating mechanism 11′ and lies above this pick-up region 39′.

The layout of this system 1 differs from that of the embodiments described above solely due to the design and layout of the separating mechanisms 11′, 12′. The two separating mechanisms 11′, 12′ respectively have a frame 160 comprising two side parts 159 extending transversely to the conveying direction—indicated by arrow 9—spaced at a distance apart from one another and the frame 160 is preferably releasably connected to the base frame 6 supported on a standing surface 8.

The separating mechanisms 11′ and 12′ for conveying and separating elongate parts 2 from a part quantity are disposed one after the other in a row in the conveying direction—indicated by arrow 9—extending transversely to their longitudinal extension and the discharge portion 87 of the conveyor element 47 of the first separating mechanism 11′ extends as far as a pick-up region 41′ of the second separating mechanism 12′.

The elongate parts 2 in this instance are deposited at the dispatch point on the belt conveyor 18 as a quantity of goods and conveyed along it in the direction towards the pick-up region 39′ and in the pick-up region 39′ drop down onto the conveyor element 47 of the first separating mechanism 11′. As explained in detail above in connection with FIGS. 6, 8 and 9, the conveyor element 47 of the two separating mechanisms 11′, 12′ is provided in the form a plurality of driver elements 46 disposed one after the other in the conveying direction of the elongate parts 2—indicated by arrow 9—spaced apart from one another by a spacing gap 99. Alternatively, the conveyor element 47 may also be provided in the form of the endless conveyor belt, as illustrated in FIG. 14. The endless conveyor element 47 is in turn displacingly coupled with the drive elements 54 disposed on either side of it, in particular drive chains, as schematically illustrated by dotted-dashed lines. Each of the two drive elements 54 is guided by means of a drive wheel 57 coupled with a drive 55, not illustrated, and several pulley blocks 56. Rotatably mounted on oppositely lying side parts 159 are at least a drive wheel 57 and the mutually spaced, axially parallel pulley blocks 56, the two drive wheels 57 being driven in synchronization, and in particular coupled by means of a common drive shaft 58, not illustrated.

The two side parts 159 are respectively equipped with a plate segment, not illustrated, extending between the two horizontally spaced pulley blocks 56 facing the pick-up region 39′, which forms a slide track across at least a part-length of the drive element 54, in particular in the form of a slot, for guiding the respective drive element 54 along it.

The pick-up region 39′, 41′ is respectively formed by the first strand of the conveyor element 47 directed towards it and extends across a part-portion 161 or part-length of the first strand, and the pick-up region 39′, 41′ or the part-portion has a concave, in particular arcuate contour facing a horizontal plane 79 lying above the pick-up region 39′, 42′. The pick-up region 39′, 41′ therefore has a tub-shaped cross-sectional contour.

The pick-up region 39′, 42′ lies underneath the separating and discharge portion 86, 87 and extends into the driving portion 85. As viewed in the cross-sectional plane, the pick-up region 39′, 42′ is essentially formed by a circle segment or bounded by a circle segment, the chord 162 of which intersects the driving portion 85 and extends essentially parallel with or inclined at an angle to the horizontal plane 79 extending above the pick-up region 39′, 42′ and a center point angle 163 is between 50° and 90°, for example 60°. A radius 164 of the concave part-portion of the conveyor element 47 of the circle segment of the first separating mechanism 11′ is bigger than the radius of the concave part-portion of the conveyor element 47 or circle segment of the second separating mechanism 12′. The radius 164 of the concave part-portion of the conveyor element 47 of the first separating mechanism 11′ is approximately 1.2-times to 1.5-times, in particular 1.4-times the radius 164 of the concave part-portion of the conveyor element 47 of the second separating mechanism 12′. The radius 164 of the concave part-portion of the conveyor element 47 of the second separating mechanism 12′ is approximately 1.1-times to 1.4-times, in particular 1.2-times the maximum length 32 of the elongate part 2. The advantage of the latter is that it is firstly conductive to orienting the elongate parts 2 in the pick-up region 42′ in a position essentially parallel with the longitudinal extension of the driver elements 46 and secondly, prevents the elongate parts 2 from becoming jammed in the pick-up region 42′. The length 32 of the elongate parts 2 is between approximately 60 mm and 350 mm, in particular 100 mm and 300 mm, for example 260 mm. Side walls are provided on either side of the endless conveyor element 47, although these are not illustrated, laterally bounding the pick-up region 39′, 41′.

The driven, circulating conveyor element 47 picks up individual elongate parts 2 from the part quantity of elongate parts 2 in the pick-up region 39′, 41′ with its driver elements 46 in the recessed groove 90 and conveys them from the driving portion 85 extending into the pick-up region 39′, 41′ in the direction of the discharge portion 87. If several elongate parts 2 become hooked in one another, they are separated out in the separating region 86 due to the shift of the common center of gravity outside of the recessed groove 90 and returned to the pick-up region 39′, 41′, as described above.

The strand of the conveyor element 47 extending adjacent to the pick-up region 41 and between it and the discharge region 51, in particular the pulled strand, is divided into a more or less concavely curved driving portion 85, the separating region 86 and the discharge portion 87 directed towards the pick-up region 39′, 41′. The discharge portion 87 extends across wide parts in an essentially straight line and parallel with the horizontal plane 79, whilst the separating region 86 is of an inclined and straight design, as described above in connection with the preceding drawings.

To ensure optimum separation efficiency at the second separating mechanism 12′, a ratio of the number of elongate parts 2 in the pick-up region 39′, 41′ between the first and second separating mechanism 11′, 12′ is approximately up to 10:1, in particular 5:1. The filling volume of the first and second pick-up region 39′, 41′ is therefore bounded by the circle segment. The filling status in the pick-up regions 39′, 41′ in the first and second separating mechanism 11′, 12′ is respectively monitored by one or two monitoring elements 42, 116 in the form of sensors disposed in the pick-up region 39′, 41′, as described above. The sensor or sensors of the pick-up regions 39′, 41′ are disposed on a level with the chord 162. The elongate parts 2 are intermittently delivered to the pick-up region 39′, 41′ by the first inlet conveyor system 10 on the one hand and the first separating mechanism 11′ on the other. As soon as the desired filling level is reached in the pick-up region 41′, the delivery of elongate parts 2 from the first separating mechanism 11′ is interrupted by switching off the first separating mechanism 11′. Likewise, the first inlet conveyor system 10 is switched off as soon as the desired filling level is reached in the pick-up region 39′.

FIGS. 19 and 20 are highly simplified diagrams illustrating a side view of other designs of the conveyor elements 47 of the first and/or second separating mechanism 11′, 12′ for conveying and separating elongate parts 2 from a part quantity in a conveying direction—indicated by arrow 9—extending transversely to their longitudinal extension. This conveyor element 47 may also be a conveyor belt or the mutually displaceable driver elements 46, not illustrated, connected to drive elements 54, not illustrated, disposed on either side of the conveyor element 47.

As may be seen from FIG. 19 and FIG. 18, a straight connecting line 166 extending between the parallel axes 165 of the pulley block and wheels 56, 57 or two pulley blocks adjacent to the pick-up region 39′, 41′, vertically one above the other and horizontally offset, and the horizontal plane lying above the pick-up region 39′; 42′ subtend an angle 167 of less than 90°, in particular between 30° and 60°, for example 45°. The axes 165 extend perpendicular to the side parts 159 or a cross-sectional plane of the separating mechanism 11′, 12′. The side parts 159 are disposed parallel with one another and are oriented perpendicular to the horizontal plane 79.

The chord 162 extends inclined at an angle with respect to the horizontal plane 79 running above the pick-up region 39′, 41′ and has a center point angle 163 of between 90° and 140°, for example 120°. Rotatably mounted on the side parts 159 lying opposite one another at a distance apart transversely to the conveying direction—indicated by arrow 9—are at least a drive wheel 57 and the pulley blocks 56, the two drive wheels 57 being driven in synchronization, in particular being coupled by a common drive shaft 58, not illustrated.

In the embodiment illustrated in FIG. 20, the connecting line 166 and the chord 162 extend parallel with the horizontal plane 79 disposed above the pick-up region 39′; 41′. The center point angle 163 is 180°. The circle segment bounding the pick-up region 39′, 41′ is semi-circular in this embodiment.

As may also be seen from FIGS. 19 and 20, the chord 162 intersects the inlet start of the separating region 86.

The geometry of the conveyor element 47 will depend on the structural design of the elongate parts 2 and the separating mechanisms 11, 11′, 12, 12′ may be individually adapted to the type of elongate part 2 so that maximum separation performance can be achieved at the second separating mechanism 12, 12′.

FIG. 21 illustrates a different embodiment of a part-portion of the conveyor element 47. The conveyor element 47 has the two driver elements 46 articulatingly linked to one another by drive elements 54 on either side of it, in particular drive chains, as described above. The mutually facing longitudinal edges 100 of the driver elements 46 disposed one immediately following the other in the conveying direction—indicated by arrow 9—are respectively provided in the form of a section, in particular a sawtooth section, and has trapezoidal section peaks 168 and trapezoidal section valleys 46 alternating one after the other in the longitudinal extension of the driver elements 46. The section peaks 168 of the one driver element 46 mesh in the section valleys 169 of the other driver element 46, and the spacing gap 99 is formed between them. The section peaks 168 and section valleys 169 are of a complementary design and lie opposite one another by reference to the articulation axis 101. The spacing gap 99 is bounded by two oppositely lying longitudinal edges 100 of complementary design, in particular the section peaks 168 and section valleys 169 lying adjacent to one another in a row of the driver elements 46 disposed one immediately after the other in the conveying direction—indicated by arrow 9- and essentially more or less correspond to the smallest cross-sectional dimension 34 of the elongate part 2 (as illustrated in FIG. 1). The longitudinal edges 100 are slightly offset from the articulation axis 101 of two articulatingly connected chain links 70. The section valleys 169 are respectively bounded by section flanks 170 of the section peaks 168 extending towards one another at an angle and a flat section base 171 extending parallel with the articulation axis 101, whilst the section peaks 168 are respectively bounded by the inclined section flanks 170 and a flat section top surface 172 extending parallel with the articulation axis 101. A minimum height 173 of the section peaks 168 between the section base 171 and the section top surface 172 and a minimum depth 174 of the section valleys 169 between the section top surface 172 and the section base 171 are at least slightly bigger than the spacing gap 99 bounded by the section peaks 168 and section valleys 169.

Finally, it should be pointed out that any combination of the separating mechanisms 11, 11′, 12, 12′ with one another is possible and they may also be disposed in any orientation with respect to one another. It has also proved to be of practical advantage if the transport speed of the elongate parts 2 along the system 1, starting from the first inlet conveyor system 10, first and second separating mechanism 11, 11′, 12, 12′, first discharge unit 13, orienting mechanism 14, second discharge unit 15, buffer run 16 through to the second inlet conveyor system 17, is respectively increased by the factor of between 1.05 and 1.1.

The examples of embodiments are intended to illustrate possible variants of the system 1 with its separating mechanisms 11, 11′, 12, 12′, and it should be pointed out at this stage that the invention is not restricted to the embodiments specifically illustrated, and instead the individual design variants may be used in different combinations with one another and these possible variations lie within the reach of the person skilled in this technical field given the disclosed technical teaching. Accordingly, all conceivable design variants which can be obtained by combining individual details of the design variants described and illustrated are possible and fall within the scope of the invention.

FIGS. 13; 14 and 18 to 20; 21 illustrate another embodiment of the separating mechanism 11, 11′, 12, 12′ which may be construed as a separate embodiment in its own right, the same reference numbers being used for parts that are the same as those illustrated in FIGS. 1 to 12.

For the sake of good order, finally, it should be pointed out that in order to provide a clearer understanding of the structure of the system 1 and separating mechanism 11, 11′, 12, 12, they and their constituent parts are illustrated to a certain extent out of scale and/or on an enlarged scale and/or on a reduced scale.

List of reference numbers
1 System
2 Elongate part
3 Assembly and/or processing unit
4 Section
5 Section
6 Base frame
7 Support foot
8 Standing surface
9 Arrow
10 Inlet conveyor system
11 Separating mechanism
11 Separating mechanism
12 Separating mechanism
12 Separating mechanism
13 Discharge unit
14 Orienting mechanism
15 Discharge unit
16 Buffer run
17 Inlet conveyor system
18 Belt conveyor
19 Belt conveyor
20 Support frame
21 Drive
24 Supply container
25 Inlet chute
26 Frame
27 Pulley block
28 Drive
29 Drive roller
30 Conveyor belt
31 Driver element
32 Length
33 Width
34 Cross-sectional dimension
37 Chute base
38 Chute side wall
39 Pick-up region
39 Pick-up region
40 Discharge region
41 Pick-up region
41 Pick-up region
42 Monitoring element
43 Deflector plate
44 Supply container
45 Inlet chute
46 Driver element
47 Conveyor element
48 Frame
49 Chute base
50 Chute side wall
51 Discharge region
52 Side part
53 Cross-member
54 Drive element
55 Drive
56 Pulley block
57 Drive whell
58 Drive shaft
59 Drive whell
60 Pulley block
61 Traction means
62 Protective housing
63 Vertical distance
64 Strand
65 Slide track
66 Guide surfaces
67 Plate segment
68 Plate segment
69 Bolt
70 Chain link
71 Roller
72 Plate
73 Width
74 End face
75 Engagement surface
76 End face
77 Plate segment
78 Guide surface
79 Horizontal plane
80 Strand
81 Guide surface
82 Support plate
83 Tensioning unit
84 Arrow
85 Driving portion
86 Separating regio
87 Discharge portion
88 Angle of inclination
89 Angle
90 Recessed groove
91 Drop shaft
92 Deflector plate
93 Side wall
94 Linear guide
95 Connecting plate
96 Longitudinal mid-plane
97 Linking plate
98 Support plate
99 Spacing gap
100 Longitudinal edge
101 Articulation axis
102 Length
103 Mounting surface
104 Groove base
105 Guide surface
106 Angle
107 Base
108 Leg
109 Narrow side
110 Deflector surface
111 Depth
112 Normal distance
113 Surface center of gravity
114 Width
115 Engagement surface
116 Monitoring element
117 Monitoring element
118 Frame
119
120 Section
121 Support frame
122 Side frame part
123 Support plate
124 Conveyor passage
125 Inlet region
126 Outlet region
127 Longitudinal mid-axis
128 Conveyor surface portion
129 Conveying and orienting rollers
130 Conveying and orienting rollers
131 Distance
132 Inlet roller
133 Rotation axis
134 Narrow region
135 Conveyor surface
136 Radius
137 Radius
138 Radius
139 Angle
140 Transition region
141 Longitudinal distance
142 Deflector element
143 Deflector surface
144 Gear
145 Gear
146 Drive wheel
147 Drive motor
148 Drive shaft
149 Locking element
150 Rotation axis
151 Drive shaft
153 Camera system
154 Discarded parts container
155 Chute
156 Handling device
157 Handling device
158
159 Side part
160 Frame
161 Part-portion
162 Chord
163 Center point angle
164 Radius
165 Axis
166 Connecting line
167 Angle
168 Section peak
169 Section peak
170 Section peak
171 Section base
172 Section top surface
173 Height
174 Depth

1. Separating mechanism (11′; 12; 12′) for conveying and separating elongate parts (2) from a part quantity in a conveying direction (9) extending transversely to their longitudinal extension, with a pick-up region (39′; 41; 41′) for a part quantity of elongate parts (2) and a discharge region (51) for elongate parts (2) separated from the part quantity disposed above it, with at least one endlessly circulating, driveable conveyor element (47) extending between the pick-up region (39′; 41; 41′) and the discharge region (51), which conveyor element (47) has driver elements (46) disposed one after the other in the conveying direction (9) and extending parallel with one another transversely to the conveying direction (9), wherein each driver element (46) has at least one recessed groove (90) on its external face directed towards the pick-up region (39′; 41; 41′) extending in its longitudinal direction and open in the direction towards the pick-up region (39′; 41; 41′) with an approximately trapezoidal cross-section for accommodating elongate parts (2) as and when necessary, and a length of the recessed groove (90) corresponds to at least twice the maximum length (32) of the elongate part (2) and the recessed groove (90) is bounded by a groove base (104) and guide surfaces (105) extending at an angle towards one another, and the planes of the two guide surfaces (105) subtend an angle (106) of less than 90°.

2. Separating mechanism according to claim 1, wherein the conveyor element (47) is provided in the form of a conveyor belt guided round at least one drive wheel (57) and at least one pulley block (56), and the driver elements (46) are formed by conveyor belts, in particular are integrally joined thereto.

3. Separating mechanism according to claim 1, wherein the conveyor element (47) is formed by a plurality of mutually separate driver elements (46) which can be displaced relative to one another, and endlessly circulating drive elements (54) are disposed on either side of the conveyor element (47) spaced at a distance apart from one another transversely to the conveying direction (9) of the elongate parts (2), and driver elements (46) extend between the oppositely lying drive elements (54) parallel with one another and separated from one another in the conveying direction (9) of the elongate parts (2) by a spacing gap (99), and every driver element (46) is connected to the drive elements (54) so as to be fixed therewith in displacement.

4. Separating mechanism according to claim 1, wherein the drive elements (54) are formed by endlessly circulating drive chains, comprising chain links (70) articulatingly connected to one another by bolts (69) extending parallel with one another and guided round at least one drive wheel (54) and at least one pulley block (56), and the driver elements (46) extend respectively between two chain links (70) of the drive chains lying symmetrically opposite one another by reference to a longitudinal mid-plane (96) parallel with one another and separated from one another in the conveying direction (9) of the elongate parts (9) by the spacing gap (99), and every driver element (46) is connected to the oppositely lying chain links (70) of the drive chains so as to be fixed in displacement therewith, and longitudinal edges (100) of two driver elements (46) disposed one after the other in the conveying direction (9) extend opposite from one another by reference to an articulation axis (101) between two chain links (70) as well as slightly offset from the articulation axis (101), which longitudinal edges (100) bound the spacing gap (99) which more or less corresponds to the minimum cross-sectional dimension (34) of the elongate part (2) or is smaller than a minimum cross-sectional dimension (34) of the elongate part (2).

5. Separating mechanism according to claim 1, wherein the longitudinal edges (100) of two driver elements (46) of the conveyor element (47) disposed one after the other are respectively formed by a section with section peaks (168) disposed one after the other in the longitudinal extension of the driver elements (46) alternating with section valleys (169) recessed with respect thereto, and the section peaks (168) of the first driver element (46) project into the section valleys (169) of the other driver element (46) and bound the spacing gap (99).

6. Separating mechanism according to claim 1, wherein a strand of the conveyor element (47) extending between the pick-up region (39′; 41; 41′) and the discharge region (51) and directed towards the pick-up region (39′; 41; 41′) is divided into a driving portion (85), a separating region (86) and a discharge portion (87) and the driving portion (85) directed towards the pick-up region (39′; 41; 41′) is concavely curved, the separating region (86) runs across wide parts in an essentially straight line and is inclined with respect to a horizontal plane (79) and the discharge portion (87) runs across wide parts in an essentially straight line and is parallel with the horizontal plane (79).

7. Separating mechanism according to claim 1, wherein a strand of the conveyor element (47) extending between the pick-up region (39′; 41; 41′) and the discharge region (51) and directed towards the pick-up region (39′; 41; 41′) is divided into a driving portion (85), a separating region (86) and a discharge portion (87) and the driving portion (85) runs in the extension of the separating region (86) and across wide parts in an essentially straight line, and the discharge portion (87) runs across wide parts in an essentially straight line and is parallel with the horizontal plane (79).

8. Separating mechanism according to claim 6, wherein an angle of inclination (88) of the separating region (86) by reference to the horizontal plane (79) is less than 90°.

9. Separating mechanism according to claim 8, wherein the angle of inclination (88) of the separating region (86) by reference to the horizontal plane (79) is between 60° and 85°.

10. Separating mechanism according to claim 6, wherein an angle (89) subtended between a tangent (T) at the apex point (S) of the concave driving portion (85) and a chute base (49) of an inlet chute (45) or the straight driving portion (85) and a chute base (49) of an inlet chute (45) is less than 90°.

11. Separating mechanism according to claim 10, wherein the angle (89) is between 55° and 80°.

12. Separating mechanism according to claim 1, wherein the pick-up region (41) is formed by an inlet chute (45) of a supply container (44) disposed on a frame (48) of the separating mechanism (12) and bounded by part-regions of the inlet chute (45) and the strand of the conveyor element (47) directed towards it, in particular its driving portion (85).

13. Separating mechanism according to claim 1, wherein the pick-up region (39′; 41; 41′) is formed by a concave part-portion (161) of a strand of the conveyor element (47) directed towards it and has a tub-shaped cross-sectional contour.

14. Separating mechanism according to claim 13, wherein, as viewed in the cross-sectional plane, the pick-up region (39′; 41; 41′) is essentially formed or bounded by a circle segment, the chord (162) of which intersects the driving portion (85), in particular in the conveying direction (9) shortly before the inlet start of the separating region (86), or intersects the inlet start of the separating region (86) and extends essentially parallel with or inclined at an angle with respect to the horizontal plane (79), and a center point angle (163) is between 50° and 90°.

15. Separating mechanism according to claim 1, wherein at least one drive wheel (57) and several pulley blocks (56) are respectively rotatably mounted at two oppositely lying vertical side parts (159) of a frame (160) of the separating mechanism (11′; 12′) disposed at a distance apart transversely to the conveying direction (9), and an angle (167) subtended by the parallel axes (165) of the pulley blocks and/or the drive wheel (56, 57) extending adjacent to the pick-up region (39′, 41′), disposed vertically one above the other and horizontally offset from one another, is less than 90°, in particular between 30° and 60°, for example 45°.

16. Separating mechanism according to claim 1, wherein at least one drive wheel (57) and several pulley blocks (56) are respectively rotatably mounted at two oppositely lying vertical side parts (159) of a frame (160) of the separating mechanism (11′; 12′) disposed at a distance apart transversely to the conveying direction (9), and a connecting line (166) extending between the parallel axes (165) of the pulley blocks and/or drive wheels (56, 57) adjacent to the pick-up region (39′ 41′), disposed vertically one above the other and horizontally offset from one another, and the horizontal plane (79) extend parallel with one another.

17. Separating mechanism according to claim 1, wherein the conveyor element (47) or every drive element (54) is guided along a slide track (65) extending along each side part (52; 159) of the frames (48; 160) between at least the pick-up region (39′; 41; 41′) and the discharge region (51) of the conveyor element (47).

18. Separating mechanism according to claim 1, wherein every driver element (46) has an approximately C-shaped cross-section and a base (107) remote from the pick-up region (39′; 41; 41′) and two legs (108) extending out from the base (107).

19. Separating mechanism according to claim 18, wherein a free end of the front first leg (108) projects in the conveying direction (9) of the elongate parts (2) alongside a free end of the rear second leg (108) in the conveying direction (9) of the elongate parts (2).

20. Separating mechanism according to claim 18, wherein a free end of the front first leg (108) in the conveying direction (9) of the elongate parts (2) is inclined with respect to the groove base (104) and forms a deflector surface (110), and the groove base (104) and the deflector surface (110) subtend an angle.

21. Separating mechanism according to claim 18, wherein the base (107) forms the groove base (104) and the first and second legs (108) form the mutually facing guide surfaces (105).

22. Separating mechanism according to claim 18, wherein a minimum depth (111) of the recessed groove (90) is at least slightly bigger than a normal distance (112) measured between a surface center of gravity (113) of the individual elongate part (2) lying in the cross-sectional plane and the groove base (104).

23. Separating mechanism according to claim 18, wherein a width (114) of the recessed groove (90) approximately corresponds to the maximum cross-sectional dimension (34) of the individual elongate part (2).

24. Separating mechanism according to claim 1, wherein the angle (106) is between 20° and 30°.

25. System (1) for conveying and separating elongate parts (2), comprising a first inlet conveyor system (10) for a randomly disposed quantity of elongate parts (2), disposed downstream of it in the conveying direction (9) of the elongate parts (2) a first separating mechanism (11; 11′) for the randomly disposed elongate parts (2) and downstream of it in the conveying direction (9) of the elongate parts (2) a second separating mechanism (12; 12′) for a part quantity of elongate parts (2) which may or may not have been separated, and, downstream of it in the conveying direction (9) of the elongate parts (2) a first discharge unit (13) for the separated elongate parts (2), and the separating mechanisms (11; 11′; 12; 12′) each comprise at least one endlessly circulating conveyor element (47), wherein the first and/or second separating mechanism (11; 11′; 12; 12′) is specifically of the type according to claim 1, and a ratio of the number of elongate parts (2) in the pick-up region (39, 41; 39′, 41′) between the first and second separating mechanism (11, 12; 11′, 12′) is approximately up to 10:1.

26. System according to claim 25, wherein the conveyor element of the first separating mechanism (11) is formed by a conveyor belt (30) with the driver elements (31) disposed in a conveying direction (9) extending transversely to the longitudinal extension of the elongate parts (2) at a distance one after the other and directed towards the pick-up region (39) and has a width (33) corresponding to at least twice the maximum length (32) of the elongate part (2).

27. System according to claim 25, wherein a first inlet chute (25) extends between the first inlet conveyor system (10) and the first separating mechanism (11) and a second inlet chute (45) extends between the first and second separating mechanism (11, 12), and a first chute base (37) of the first inlet chute (25) is downwardly inclined in the direction towards the first separating mechanism (11) and a second chute base (49) of the second inlet chute (45) is downwardly inclined in the direction towards the second separating mechanism (12).

28. System according to claim 25, wherein the first and second separating mechanism (11; 11′; 12; 12′) are disposed directly adjacent to one another in a row and the conveyor element (47) of the second separating mechanism (12′) forms the concavely curved pick-up region (41′), and a discharge region (41; 51) of the first separating mechanism (11; 11′), in particular a deflection region of the conveyor belt (30) or an essentially horizontal discharge portion (87) is disposed above the pick-up region (41′) of the second separating mechanism (12; 12′) and projects beyond this pick-up region (41′).

29. System according to claim 28, wherein the first and second separating mechanism (11; 11′; 12; 12′) are disposed in a row one immediately after the other in the conveying direction (9).

30. System according to claim 28, wherein the first and second separating mechanism (11; 11′; 12; 12′) are rotated by 90° with respect to one another.

31. System according to claim 25, wherein a ratio of the number of elongate parts (2) in the pick-up region (39, 41; 39′, 41′) between the first and second separating mechanism (11, 12; 11′, 12′) is up to approximately 5:1.

32. System (1) for conveying, separating and orienting elongate parts (2), comprising a first inlet conveyor system (10) for a randomly disposed quantity of elongate parts (2), downstream of it in the conveying direction (9) of the elongate parts (2) a first separating mechanism (11; 11′) for the randomly disposed elongate parts (2) and optionally downstream of it in the conveying direction (9) of the elongate parts (2) a second separating mechanism (12; 12′) for a part quantity of elongate parts (2) which may or may not have been separated, and, downstream of it in the conveying direction (9) of the elongate parts (2) a first discharge unit (13) for the separated elongate parts (2), wherein the system (1) for conveying and separating elongate parts (2) is specifically of the type according to claim 24, and downstream of the first discharge unit (13) in the conveying direction (9) of the elongate parts (2) is an orienting mechanism (14) for the elongate parts (2) conveyed parallel with the conveying direction (9), which has a frame (118) extending between an inlet region (125) adjacent to the first discharge unit (13) and an outlet region (126) lying opposite it in the conveying direction (9) with two parallel side frame parts (122) spaced at a distance apart from one another transversely to the conveying direction (9) and at least one driveable conveying and orienting element mounted between the side frame parts (122), which conveying and orienting element forms a shaft-type conveyor passage, the cross-sectional dimension of which becomes smaller starting form the inlet region (125) in the direction towards the outlet region (126) and which is bounded by conveyor surface portions (128) which taper in the direction towards a vertical longitudinal mid-plane (127) of the conveyor passage extending parallel between the side frame parts (122).

33. System according to claim 32, wherein the conveying and orienting element is formed by at least two endlessly circulating traction means, in particular belts, the first of which traction means is disposed in the inlet region (125) and the second of which traction means is disposed in the outlet region (126), each forming a conveyor surface (135) comprising at least two lateral conveyor surface portions (128) inclined towards one another symmetrically with respect to the longitudinal mid-plane (127) and a base-side conveyor surface portion (128) extending between them, and, as viewed in the cross-sectional plane transversely to the conveying direction (9), the two lateral, mutually facing conveyor surface portions (128) diverge from the bottom to the top respectively at an angle of 60° with respect to the vertical longitudinal mid-plane (127) in the inlet region (125) and at an angle of 45° with respect to the longitudinal mid-plane (127) in the outlet region (126) so that the conveyor passage (124) is of an approximately trapezoid shape in cross-section and the cross-sectional dimension in the inlet region (125) is bigger than the cross-sectional dimension in the outlet region (126).

34. System according to claim 33, wherein the cross-sectional dimension is respectively constant across the length of the inlet and outlet region (125, 126).

35. System according to claim 33, wherein the base-side conveyor surface portion (128) is formed by a third traction means, in particular belt, which extends across a distance corresponding to the width between the lateral conveyor surface portions and the length of the conveyor passage (124) of trapezoidal cross-section.

36. System according to claim 32, wherein the conveying and orienting element is formed by several conveying and orienting rollers (129, 130) in the shape of an egg timer disposed in a horizontal plane spaced at a distance (131) apart from one another between the inlet and outlet region (125, 126) in the conveying direction (9) extending parallel with the longitudinal extension of the elongate part (2), which are coupled via a drive mechanism with at least one drive motor (147).

37. System according to claim 36, wherein the conveying and orienting rollers (129, 130) are mounted on the side frame parts (122) so as to be rotatable respectively about a rotation axis (133) oriented perpendicular to them and respectively have a radially extending narrow region (134) in a middle portion by reference to their longitudinal extension bounded by the conveyor surface portions (128).

38. System according to claim 37, wherein the narrow region (134) is bounded by a concave conveyor surface (135) made up of the conveyor surface portions (128) disposed symmetrically with respect to the longitudinal mid-plane (127) and is approximately U-shaped.

39. System according to claim 37, wherein the narrow region (134) is bounded by a conveyor surface (135) made up of at least two flat conveyor surface portions (128) inclined towards one another and disposed symmetrically with respect to the longitudinal mid-plane (127) and is of a V-shaped or trapezoidal design and the planes of two surface portions (128) lying opposite one another transversely to the conveying direction (9) of the elongate parts (2) subtend an angle (139).

40. System according to claim 38, wherein a radius (136) of the concave or arcuate conveyor surface (135) of the at least one conveying and orienting roller (129) in the inlet region (125) is approximately the same as or slightly bigger than a maximum cross-sectional dimension (34) of the elongate part (2).

41. System according to claim 38, wherein a radius (137) of the concave or arcuate conveyor surface (135) of the at least one conveying and orienting roller (130) in the outlet region (126) is smaller than a maximum cross-sectional dimension (34) of the elongate part (2).

42. System according to claim 36, wherein at least two conveying and orienting rollers (129) are disposed in the inlet region (125) and at least two conveying and orienting rollers (130) are disposed in the outlet region (126).

43. System according to claim 36, wherein an inlet roller (132) is additionally disposed upstream of the conveying and orienting roller (129) in the inlet region (125) in the conveying direction (9) of the elongate parts (2).

44. System according to claim 38, wherein the radius (129) of the concave conveyor surface (135) or angle (139) subtended by the two oppositely lying conveyor surface portions (128) of the conveying and orienting roller (129) in the inlet region is bigger than the radius (130) or angle (139) of the conveying and orienting rollers (130) disposed in the outlet region (126) so that the cross-sectional dimension of the conveyor passage (124) in the inlet region (125) is bigger than the cross-sectional dimension in the outlet region (125).

45. System according to claim 36, wherein the conveying and orienting rollers (129) in the inlet region (125) are each of the same radius (136) or angle (139) and the conveying and orienting rollers (130) in the outlet region (126) are reach of the same radius (137) or angle (139) so that the cross-sectional dimension of the conveyor passage (124) respectively remains continuously constant across the entire length of the inlet and outlet region (126).

46. System according to claim 36, wherein a longitudinal distance (141) between a rotation axis (133) of the inlet roller (132) disposed upstream of the first conveying and orienting roller (129) in the inlet region (125) in the conveying direction (9) of the elongate part (2) and a rotation axis (133) of the last conveying and orienting roller (130) in the outlet region (126) in the conveying direction (9) of the elongate part (2) approximately corresponds to the maximum length (32) of the elongate part (2).

47. System according to claim 36, wherein at least one deflector element (142) is disposed between two consecutive conveying, orienting and inlet rollers (129, 130, 132), which has a deflector surface (143) more or less conforming to the contour of the narrow region (134) and disposed slightly below the conveyor surface (135).

48. System according to claim 36, wherein the conveying, orienting and inlet rollers (129, 130, 132) of the orienting mechanism (14) are disposed separately at a slight distance (131) from one another in a row in the conveying direction (9) and are mounted on two vertically upright side frame parts (122) so as to be rotatable about the rotation axes (133) extending perpendicular thereto and the orienting mechanism (14) comprises a drives mechanism, in particular a toothed gear or traction means gear, and a drive motor (147), and the conveying, orienting and inlet rollers (129, 130, 132) are coupled via the drive mechanism with the drive motor (147).

49. System according to claim 32, wherein a second discharge unit (15) is disposed downstream of the orienting mechanism (14) in the conveying direction (9) of the elongate parts (2), which has a separating system for incorrectly oriented or damaged elongate parts (2), which separating system has an image-processing camera system (153), in particular a CCD scanner camera, and a gating-out unit.
